(19) United States
(12) Patent Application Publication
(10) Pub. No.: US 2019/0057700 A1
(43) Pub. Date: Feb. 21, 2019

(54) METHOD AND APPARATUS FOR RECOGNIZING COMMUNICATIONS BASED ON BIOLOGICAL SIGNALS

(71) Applicant: INVICTA MEDICAL, INC., Santa Clara, CA (US)

(72) Inventors: Harold Byron Kent, Portola Valley, CA (US); Robert Douglas Kent, Portola Valley, CA (US); Karena Yadira Puldon, Northridge, CA (US); Steven Thomas Kent, Portola Valley, CA (US)

(21) Appl. No.: 16/051,352

(22) Filed: Jul. 31, 2018

Related U.S. Application Data
(60) Provisional application No. 62/548,046, filed on Aug. 21, 2017.

(51) Int. Cl. G10L 15/25; G06F 3/01; G10L 15/02; G10L 15/30

(52) U.S. Cl. CPC G10L 15/25; G10L 15/30; G10L 15/02; G06F 3/015

(57) ABSTRACT

A communication device that can fit within an oral cavity of a person includes a number of contacts and a control circuit adapted to be positioned within the oral cavity. The number of contacts are configured to obtain one or more signals indicative of activity in at least an upper airway of the person. The control circuit is configured to interpret a communication provided by the person based at least in part on the one or more obtained signals.

### CROSS-REFERENCE TO RELATED APPLICATIONS

This Application claims priority under 35 U.S.C. § 119(e) to co-pending and commonly-owned U.S. Provisional Patent Application No. 62/548,046 entitled “METHOD AND APPARATUS FOR RECOGNIZING COMMUNICATIONS BASED ON BIOLOGICAL SIGNALS” filed Aug. 21, 2017, the entirety of which is hereby incorporated by reference herein.

### TECHNICAL FIELD

Aspects of the present disclosure relate generally to speech recognition, and specifically to interpreting a person's communications using signals obtained within an oral cavity of the person.

### BACKGROUND OF RELATED ART

Speech recognition devices are those that allow a person's speech to be electronically recognized and then stored, transmitted, displayed, further processed, or any combination of the above. Many speech recognition devices operate by detecting sound vibrations generated when a person speaks, and converting the detected sound vibrations into an electrical signal from which the speech may be recovered (e.g. for any of the purposes mentioned above).

Some speech recognition devices operate by detecting electrical activity occurring in a person's larynx when speaking. The most common example of this is surface electromyogram (EMG) based speech recognition. Because these devices detect electrical activity associated with muscular movement, they do not require any actual sound vibration to detect and determine speech. This allows for detection of sub-audible and silent speech in addition to audible speech, which can be advantageous in many situation including, for example, emergency aid and rescue, military operations, speech therapy, translation, assistance for disabled persons, and so on.

However, many electrical activity-based speech recognition devices suffer from a lack of portability, and require contacts and/or other sensor equipment to be attached to the face and neck area of the person. These devices are unwieldy and have an awkward appearance due to the sensor equipment attached to the person's face, which may cause discomfort to the person and prevent them from being able to move about. In addition, such devices may be susceptible to outside interference, and may have difficulty determining external locations in reference to internal anatomy, replicating data, and other accuracy problems. Current systems must also compensate for changes in location of the contacts.

Thus, there is a need for a non-invasive signal-based speech recognition system that will grant a person freedom of movement while providing a high degree of accuracy, comfort, and discreetness.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method and apparatus for detecting oral-based communications of a person are disclosed herein. In accordance with aspects of the present disclosure, a non-invasive and removable oral communication device is disclosed that may detect or obtain signals indicating activity of the muscles, tissues, and other suitable structures of the person's upper airway during the oral-based communications. The oral-based communications may include audible speech (such as normal speaking), inaudible speech (such as normal whispering), and silent speech (such as “mouthing” or miming speech). The activity may include electrical activity of the muscles, tissues, and other suitable structures of the person's upper airway, may include neural activity of the muscles, tissues, and other suitable structures of the person's upper airway, and movement of the muscles of the person's upper airway.

The communication device may process the obtained signals, combine the obtained signals to generate a composite signal, and compare the composite signal with a number of reference signals to interpret the oral-based communications. The communication device may determine one or more properties of each of the obtained signals (such as its frequency, amplitude, duty cycle, and so on), and may individually process each of the obtained signals based on its determined properties. Thereafter, the communication device may transmit the processed signals to a remote device for determination of what was spoken.

Another inventive aspect disclosed herein may allow a person to use tongue movements and gestures as commands to control a number of operations of a remote device. In some implementations, the communication device may include an appliance configured to fit within an oral cavity of a person, a first contact coupled to the appliance and configured to detect gestures made by the person's tongue, and a control circuit configured to determine commands based at least in part on gestures detected by the first contact. The first contact may be a touch sensitive contact that detects swiping gestures made by the tongue, and the control circuit may be configured to determine one or more first commands based on the tongue swiping gestures. The communication device may transmit the first commands to a remote device, and the remote device may perform one or more operations based on the first commands

In addition, or as an alternative, the communication device also may include additional contacts configured to detect clicking or tapping gestures made by the tongue. The control circuit may be configured to determine second commands based at least in part on the clicking or tapping gestures detected by the additional contacts. The communication device may transmit the second commands to a remote device, and the remote device may perform one or more operations based on the second commands

### BRIEF DESCRIPTION OF THE DRAWINGS

The present embodiments are illustrated by way of example and are not intended to be limited by the figures of the accompanying drawings, where like reference numerals refer to corresponding parts throughout the drawing figures.

FIG. 1A is a side sectional view depicting a person's upper airway.

FIG. 1B is an elevated sectional view of the person's tongue.

FIG. 2 is a top plan view of a communication device in accordance with some aspects of the present disclosure.

FIG. 3 is a block diagram of a control circuit that may be may be one implementations of the control circuit of the communication device of FIG. 2.

FIG. 4A is an illustration of signal waveforms indicative of a first phrase detected by the communication device of FIG. 2.

FIG. 4B is an illustration of signal waveforms indicative of a second phrase detected by the communication device of FIG. 2.

FIG. 4C is an illustration of signal waveforms indicative of a third phrase detected by the communication device of FIG. 2.

FIG. 4D is an illustration of signal waveforms indicative of a fourth phrase detected by the communication device of FIG. 2.

FIG. 4E is an illustration of signal waveforms indicative of a fifth phrase detected by the communication device of FIG. 2.

FIG. 4F is an illustration of signal waveforms indicative of a sixth phrase detected by the communication device of FIG. 2.

FIG. 4G is an illustration of signal waveforms indicative of a seventh phrase detected by the communication device of FIG. 2.

FIG. 4H is an illustration of signal waveforms indicative of an eighth phrase detected by the communication device of FIG. 2.

FIG. 4I is an illustration of signal waveforms indicative of various numbers detected by the communication device of FIG. 2.

FIG. 4J is an illustration of signal waveforms indicative of various numbers and words detected by the communication device of FIG. 2.

FIG. 5 illustrates a composite waveform of an electrical signal representation of speech.

FIG. 6 is an illustrative flow chart of an example operation for interpreting oral-based communications.

FIG. 7 is an illustrative flow chart of an example operation for correlating a composite signal with each of a number of reference signals.

FIG. 8 is a top plan view of a communication device.

FIG. 9 is a block diagram of a control circuit that may be one implementations of the control circuit of the communication device of FIG. 8.

FIG. 10 is an illustrative flow chart of an example operation for interpreting tongue-based commands

### DETAILED DESCRIPTION

A non-invasive method and apparatus for recognizing audible speech (such as normal speaking), inaudible speech (such as normal whispering), and silent speech (such as “mouthing” or miming speech with no externally visible movement). In some implementations, a communication device is disclosed that may fit within the oral cavity of a person. The communication device may include a plurality of contacts each to obtain signals indicative of various types of activity within or corresponding to muscles and tissues associated with portions of the person's oral cavity and upper airway proximate to the contact. The communication device may combine the signals obtained by the contacts to generate a composite signal that is indicative of various types of activity within or corresponding to muscles and tissues associated with all (or at least most) of the person's oral cavity and upper airway. The communication device may compare the composite waveform to the waveforms in a database to determine a word or phrase that was spoken. In an embodiment, the apparatus may obtain the level of electrical activity from one or more upper airway muscles, and preprocess each obtained signal based on the muscle it was obtained from prior to combining the signal with signals from other muscles. In this manner, a more accurate composite signal may be generated which will allow for increased accuracy in speech recognition. In addition, some embodiments may allow recognition of silent speech when the person's jaw is locked, thus providing additional privacy and prevention of eavesdropping.

In the following description, numerous specific details are set forth to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components, circuits, or physiological matter. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. Further, the logic levels and timing assigned to various signals in the description below are arbitrary and/or approximate, and may be modified (such as in polarity, in timing, in amplitude, in duty cycle, and so on) as desired.

As used herein, the term “activity” refers to electrical activity, neural activity, muscle movement, or any combination thereof. The term “communications” refers to audible speech, in-audible speech, whispering, and “mouthing” words or symbols. The term “substantially lateral direction” refers to a direction across the person's oral cavity in which the direction's lateral components are larger than the direction's anterior-to-posterior components (e.g., a substantially lateral direction may refer to any direction that is less than approximately 45 degrees from the lateral direction, as defined below with respect to the drawing figures). Further, as used herein, the term “reversible current” means a current that changes or reverses polarity from time to time between two controllable voltage potentials.

### Anatomical Structures of the Upper Airway

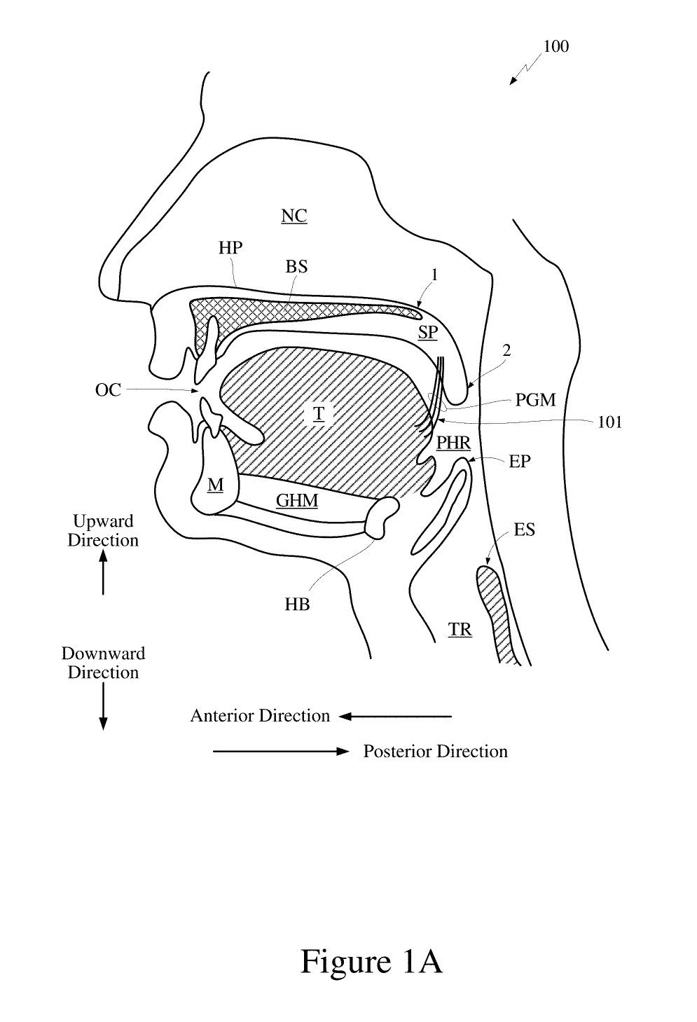

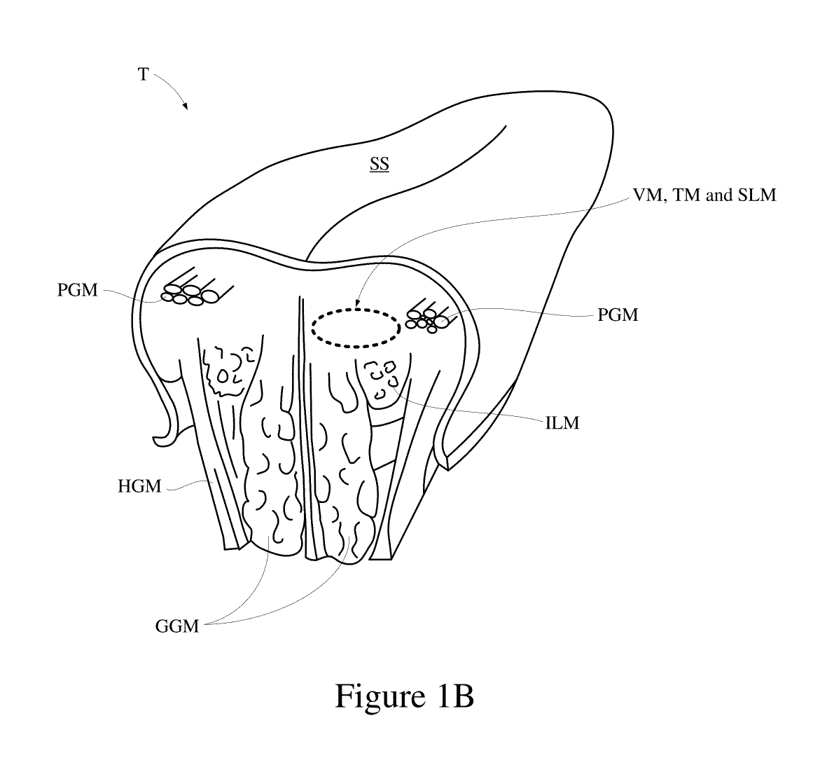

To more fully understand various aspects of the present disclosure, the muscle dynamics of speech are first described with respect to FIGS. 1A-1B, which illustrate the anatomical structures or elements of a person's upper airway (e.g., including the nasal cavity, oral cavity, and pharynx of the person). The hard palate HP overlies the tongue T and forms the roof of the oral cavity OC (e.g., the mouth). The hard palate HP includes bone support BS, and thus does not typically deform during breathing. The soft palate SP, which is made of soft material such as membranes, fibrous material, fatty tissue, and muscle tissue, extends rearward (e.g., in a posterior direction) from the hard palate HP towards the back of the pharynx PHR. More specifically, an anterior end 1 of the soft palate SP is anchored to a posterior end of the hard palate HP, and a posterior end 2 of the soft palate SP is un-attached. Because the soft palate SP does not contain bone or hard cartilage, the soft palate SP is flexible and may collapse onto the back of the pharynx PHR and/or flap back and forth (e.g., especially during sleep).

The pharynx PHR, which passes air from the oral cavity OC and nasal cavity NC into the trachea TR, is the part of the throat situated inferior to (below) the nasal cavity NC, posterior to (behind) the oral cavity OC, and superior to (above) the esophagus ES. The pharynx PHR is separated from the oral cavity OC by the Palatoglossal arch PGA, which runs downward on either side to the base of the tongue T.

Although not shown for simplicity, the pharynx PHR includes the nasopharynx, the oropharynx, and the laryngopharynx. The nasopharynx lies between an upper surface of the soft palate SP and the wall of the throat (i.e., superior to the oral cavity OC). The oropharynx lies behind the oral cavity OC, and extends from the uvula U to the level of the hyoid bone HB. The oropharynx opens anteriorly into the oral cavity OC. The lateral wall of the oropharynx consists of the palatine tonsil, and lies between the Palatoglossal arch PGA and the Palatopharyngeal arch. The anterior wall of the oropharynx consists of the base of the tongue T and the epiglottic vallecula. The superior wall of the oropharynx consists of the inferior surface of the soft palate SP and the uvula U. Because both food and air pass through the pharynx PHR, a flap of connective tissue called the epiglottis EP closes over the glottis (not shown for simplicity) when food is swallowed to prevent aspiration. The laryngopharynx is the part of the throat that connects to the esophagus ES, and lies inferior to the epiglottis EP.

The tongue T includes a plurality of muscles that may be classified as either intrinsic muscles or extrinsic muscles. The intrinsic muscles, which lie entirely within the tongue T and are responsible for changing the shape of the tongue T (e.g., for talking and swallowing), include the superior longitudinal muscle (SLM), the inferior longitudinal muscle ILM, the vertical muscle VM, and the transverse muscle TM. The extrinsic muscles, which may be used to change the position and shape of the tongue, include the Genioglossus muscle GGM, the Hyoglossus muscle HGM, the Styloglossus muscle SGM, and the Palatoglossus muscle PGM.

The superior longitudinal muscle SLM originates at the median fibrous septum and mucous membrane at the root of the tongue (close to the hyoid bone), and extends along the superior surface SS of the tongue T under the mucous membrane. Some fibers of the superior longitudinal muscle SLM extend anteriorly along the length of the tongue and insert in the mucous membrane at the tip of the tongue. Other fibers of the superior longitudinal muscle SLM extend laterally across the tongue and join the longitudinal fibers of the Styloglossus muscle, the Hyoglossus muscle, and the inferior longitudinal muscles. The superior longitudinal muscle SLM may be used to elevate, retract, and deviate the tip of the tongue T. When contracted, the superior longitudinal muscle SLM can shorten and widen the tongue.

The inferior longitudinal muscle (ILM) originates at the hyoid bone and root of the tongue, attaches to the Styloglossus muscle SGM, and inserts into the inferior part of the tongue tip. The inferior longitudinal muscle (ILM) extends along the lateral sides of the tongue T towards the tip of the tongue. More specifically, fibers of the inferior longitudinal muscle (ILM) extend anteriorly lateral to the midline on the inferior side of the tongue between the Genioglossus muscle and the Hyoglossus muscle, and blend with the fibers of the Genioglossus, the Hyoglossus muscle, and the Styloglossus muscle. When contracted, the inferior longitudinal muscle ILM pulls down and retracts the tip of the tongue, for example, to release the tip of the tongue when enunciating stop consonants. The inferior longitudinal muscle ILM may act with the Superior longitudinal muscle SLM and the Styloglossus muscle SGM to control the configuration of tongue T (such as when forming a groove to enunciate an “s” sound). The inferior longitudinal muscle ILM also may depress the tip of the tongue T and bulges the tongue T upwards, for example, to assist in the articulation of back vowels and velar consonants.

The vertical muscle (VM) is located along the midline of the tongue T, and connects the superior and inferior longitudinal muscles together. Upon contraction, the vertical muscle (VM) flattens the tongue and pushes the tongue T out laterally to make contact with the roof of the mouth in palatal and alveolar stops. The tongue position resulting from contraction of the vertical muscle VM may be used in high front vowels, and also may form a seal between the upper and lower teeth during generation (or pronunciation) of an “s” sound. The vertical muscle VM may also act independently of the other tongue muscles to flatten the middle of the tongue for grooved articulations.

The Transverse muscle TM originates at the median fibrous septum, attaches to the mucous membranes that run along the sides of the tongue T, and divides the tongue between right and left portions. When contracted, the transverse muscle TM may narrow and elongate the tongue. The transverse muscle TM may also draw the edges of the tongue upwards, for example, to allow the tongue to form a groove. The transverse muscle TM also may aid the genioglossus muscle GGM in pushing the tongue forwards for front articulations (such as when the tongue is moving in a posterior to anterior direction).

The Genioglossus muscle GGM extends from the superior mental spina on posterior surface of the mandibular symphasis. The lower fibers of the Genioglossus muscle GGM extend posteriorly back to an anterior surface of the hyoid bone. Other fibers of the Genioglossus muscle GGM fan out both anteriorly and superiorly, and may insert into the submucous fibrous tissue near the midline from the root of the tongue to near the tip. When contracted, the posterior fibers of the Genioglossus muscle GGM may protrude the tongue when the mandible is fixed, which may important in the production of nearly all sounds articulated in the front of the mouth. The anterior fibers of the Genioglossus muscle GGM may retract the tongue, and also may depress the tip of the tongue. The Genioglossus muscle GGM may help elevate the hyoid bone (and thus the larynx), may be used to protrude the tongue T, and may depress the center of the tongue T. For example, contraction of the Genioglossus muscle GGM may protrude the tongue when the mandible is stationary, which is useful in the production of nearly all sounds articulated in the front of the mouth. The Genioglossus muscle GGM also may retract the tongue (such as in an anterior to posterior to direction), and may depress the tip of the tongue, which is useful in the release of alveolar stop consonants.

The Hyoglossus muscle HGM originates on the greater horn and body of hyoid bone. The posterior and medial fibers of the Hyoglossus muscle HGM interdigitate with the Styloglossus muscle SGM and the Inferior Longitudinal Muscles at the lateral edges of the tongue. The anterior fibers of the Hyoglossus muscle HGM may attach to the mucous membrane at the tip of the tongue, and may join fibers of the Genioglossus muscle and the Inferior Longitudinal Muscles ILM. When the hyoid is fixed (such as stationary), contraction of the Hypoglossus muscle HGM can lower the tongue. When contracted, the posterior fibers of the Hyoglossus muscle HGM, which insert into the lateral edges of the tongue, can pull down the sides of the tongue, thereby serving as antagonists to the Styloglossus muscle SGM and the Palatoglossus muscle (particularly when the soft palate is stationary). The Hyoglossus muscle HGM may also work with Styloglossus muscle SGM in the production of back vowels (tongue bunching with sides down); the anterior fibers of the Hyoglossus muscle HGM may balance the forward action of the posterior genioglossus fibers to position the tongue precisely in front vowels may be used to depress the tongue T.

The Hyoglossus muscle HGM also joins the Genioglossus muscle GGM and the Inferior Longitudinal Muscles to retract the lower tongue tip. When contracted, the Hyoglossus muscle HGM also may pull down the sides, which may (along with the Styloglossus muscle SGM and the Palatoglossus muscle Palatoglossus muscle) contribute to the delicate adjustment of grooved fricatives. The Hyoglossus muscle HGM also may work with the Styloglossus muscle SGM in the production of back vowels (such as by bunching the tongue with its sides downward), and also may assist in balancing the forward action of the posterior Genioglossus muscle GGM to position the tongue T precisely in front vowels.

The Styloglossus muscle SGM originates at the anterior and lateral surface of the styloid process and the stylomandibular ligament, and attaches at the sides of the tongue. The fibers of the Styloglossus muscle SGM fan out and extend both posteriorly and anteriorly. Fibers of the anterior portion of the Styloglossus muscle SGM blend with the fibers of the Hyoglossus muscle. Fibers of the anterior portion of the Styloglossus muscle extend along the lateral edges of the tongue, and blends with the fibers from the inferior longitudinal muscle near the tip of the tongue T. Fibers of the posterior portion of the Styloglossus muscle blend with fibers of the Genioglossus muscle. When contracted, the Styloglossus muscle SGM may elevate and draw the tongue posteriorly, for example, in a manner antagonist to the Genioglossus muscle GSM. The Styloglossus muscle SGM may work together with the Genioglossus muscle GGM to position the tongue for most vowels. The Styloglossus muscle SGM may also assist in bringing the tongue T up and back for velar articulations. The Styloglossus muscle SLM may (along with the Palatoglossus muscle) help keep the sides of the tongue raised during grooved articulations such as when enunciating the letters “s” and “z”.

The Palatoglossus muscle PGM attaches to the undersurface of the soft palate and may be used to depress the soft palate SP and/or to elevate the back (posterior portion) of the tongue T. The Palatoglossus muscle PGM also aids the Styloglossus muscle SGM and inferior longitudinal muscles ILM to bulge the back of the tongue T for velars. The Palatoglossus muscle PGM connects the tongue T to both sides of the Palatoglossus arch PGA, and inserts into lateral posterior regions 101 of the base of the tongue T. When the tongue's position is fixed, the Palatoglossus muscle PGM may serve as a depressor to the soft palate.

It is noted that all of the muscles of the tongue T, except for the Palatoglossus muscle PGM, are innervated by the Hypoglossal nerve (not shown for simplicity); the Palatoglossus muscle PGM is innervated by the pharyngeal branch of the Vagus nerve (not shown for simplicity).

Referring to FIG. 1B, a plurality of different muscles may influence movement of the soft palate. In some aspects, the muscles may be classified or described as elevator muscles, tensor muscles, and depressor muscles. For example, the elevator muscles may include the levator palatine and the musculus uvulae; the tensor muscles may include tensor palatine; and the depressor muscles may include the Palatoglossus muscle PGM and the Palatopharyngeus. The musculus uvulae runs from the posterior nasal spine of the palatine bones and the palatine aponeurosis. It courses medially and posteriorly along the length of the soft palate and inserts in the mucous membrane of the uvula. On contraction, it shortens and lifts the soft palate and the uvula. It may help to close off the nasal cavity and may play some role in positioning the uvula for a uvular trill.

The tensor palatini originates at the sphenoid bone and the lateral wall of the Eustachian tube. Fibers course inferiorly and anteriorly becoming tendonous as they wind around the hamulus and spread out along the palatine aponeurosis. The tensor palatini spreads and tenses the soft palate, helping to close off the nasal cavity. It also pulls on the wall of the Eustachian tube and opens it up to equalize pressure.

The Palatopharyngeus arises from both the anterior hard palate and the midline of the soft palate with many fibers interdigitating with those from the opposite side. Some fibers arise from the edge of the auditory tube and form the Salpingopharyngeus (which we will not discuss here since it has little, if anything, to do with speech). The fibers course inferiorly and laterally, forming the posterior pillar of the fauces, inserting into the Stylopharyngeus, the lateral wall of the pharynx and the posterior border and greater cornu of the thyroid cartilage. When the thyroid cartilage and pharyngeal wall are fixed, contraction of this muscle will lower the soft palate. When the soft palate is fixed, the thyroid cartilage can presumably be raised (mostly for swallowing).

### Additional Muscles Associated with Speech

There are a plurality of muscles that influence mandibular movements that may be classified by muscles which raise and lower the mandible, thereby potentially having an influence on tongue position and mandibular motion during speech. The muscles that raise the mandible include the masseter muscle MM, the medial pterygoid MPM, and the temporalis muscle TPM. The muscles that lower the mandible include to the anterior belly of the digastric muscle ADM, the genioglossus muscle GG, the geniohyoid muscle GM, the mylohyoid muscle MYM, and the lateral pterygoid muscle LPM.

The masseter muscle (MM) has its origin at the zygomatic arch, and inserts in the ramus of the mandible. The masseter muscle MM muscle closes the jaws by elevating and drawing forwards the angle of the mandible. The medial pterygoid muscle originates in the pterygoid fossa and the medial surface of the lateral pterygoid plate. The fibers run inferiorly, laterally and posteriorly to the medial surface of the ramus and angle of the mandible. The medial pterygoid works with the masseter and temporalis to raise and protrude the mandible. It serves also as an antagonist to the anterior suprahyoid muscles to balance the lip position for labiodental fricatives and adjust the jaw position when forming an “s” during speech.

The temporalis originates from the entire temporal fossa. The fibers pass under the zygomatic arch to the anterior border of the ramus of the mandible. The function of this muscle is to raise the mandible (along with the masseter and the medial pterygoid). The posterior fibers retract the mandible slightly, assisted by the anterior suprahyoid muscles.

The anterior belly of the digastric muscle originates on the inside surface of the lower border of the mandible. The fibers course inferiorly and posteriorly to the intermediate tendon near the lesser cornu of the hyoid bone. The function of this muscle is to draw the hyoid bone up and forward. It also serves to bring the tongue forward and upward for alveolar and high front vowel articulations. In pulling up the hyoid bone, it may also pull up the larynx thereby tensing the stretching the vocal cords and raising the pitch. If the hyoid bone is fixed, the anterior belly of the digastric can serve to lower the jaw in conjunction with the geniohyoid, mylohyoid and lateral pterygoid muscles.

The Geniohyoid attaches on the anterior inner surface of the mandible at the mandibular symphasis (where the two halves of the mandible join). Fibers run posteriorly and inferiorly to the anterior surface of the body of the hyoid bone. It is close to the midline of the floor of the mouth. When the mandible is fixed, the geniohyoid (along with the lateral pterygoid, the anterior belly of the digastric and the mylohyoid) pulls the hyoid bone upward and forward. This will raise both tongue and larynx. The geniohyoid may also serve as an antagonist to the thyrohyoid, tilting the hyoid and with it the thyroid cartilage backward, for velar and uvular articulations. If the hyoid bone is fixed by other muscles, the geniohyoid can become an active jaw opener.

The mylohyoid muscle originates from the mylohyoid line along the inner surface of the mandible. Coursing medially and inferiorly, the fibers join those of the opposite side at the raphe and down to the corpus of the hyoid bone. When the mandible is fixed, the mylohyoid muscle helps to elevate the hyoid and bring it forward and with it the floor of the mouth and the tongue. With the hyoid bone fixed, the mylohyoid muscle may depress the mandible, for example, by bringing the tongue forward for alveolar articulations. The mylohyoid muscle may, along with the posterior belly of the digastric, the stylohyoid and the medial pharyngeal constrictor, cause the tongue to bulge up and back for velars. The mylohyoid muscle is also active in high vowels whether front or back, in that it raises the whole body of the tongue.

The lateral pterygoid muscle attaches to the lateral portion of the greater wing of the sphenoid bone and the lateral surface of the lateral pterygoid plate. Running horizontally and posteriorly, the fibers of the lateral pterygoid muscle insert in the pterygoid fossa and the temporo-mandibular joint. The lateral pterygoid muscle protrudes the mandible, causing the condyle to slide down and forward. This protrusion is useful in the articulation of the letter “s” and, for some people, letter “f.” The lateral pterygoid muscle can also depress the mandible along with the other depressors discussed above.

There are a plurality of muscles that influence lip movements that may be classified by muscles which close the lips, raise the upper lip, lower the bottom lip, round the lips, protrude the lips, retract the angles of the mouth, raise the corners of the mouth, and lower the angles of the mouth, thereby potentially having an influence on tongue position during speech. Lip movements may also provide a signal to one or many contacts, which could allow the device to identify and/or differentiate signal meaning. The muscle that closes the lips as well as rounds the lips is the Orbicularis Oris. The muscles that raise the upper lip include the Levator Labii Superioris, the Levator Labii Superioris Alaeque Nasi, and the Zygomaticus Minor. The muscle that lowers the bottom lip is the Depressor Labii Inferioris. The muscles that protrude the lips include the Mentalis, and the Orbicularis Oris. The muscles that retract the angles of the mouth include the Buccinator, the Risorius, and the Zygomaticus Major. The muscles that raise the corners of the mouth include the Levator Anguli Oris and the Zygomaticus Major. The muscles that lower the angles of the mouth are the depressor anguli oris and the platysma.

The orbicularis oris muscle is the sphincter muscle of the mouth, and many of the other facial muscles blend in with it. The fibers of the orbicularis oris muscle extend in several directions. The intrinsic fibers extend from the incisive slips under the nose to the mental slips at the midline under the lower lip. The extrinsic fibers arise from the buccinator through the modiolus. The uppermost and lowermost fibers go directly across the upper and lower lips to the other side. The middle fibers cross each other, the upper ones going below the lower lip and the lower ones going above upper lip. When contracted, the orbicularis oris muscle adducts the lips by drawing the lower lip up and the upper lip down, probably in conjunction with some of the other facial muscles. The orbicularis oris muscle may pull the lips against the teeth, and also may round the lips by its sphincter action.

The levator labii superioris muscle originates on the inferior orbital margin and parts of the zygomatic bone. The fibers course inferiorly and insert in the upper lip. The levator labii superioris muscle may be used to raise the upper lip. It may be used to raise the upper lip in the production of labiodental fricatives. The levator labii superioris alaeque nasi muscle originates on the frontal process of the maxilla (the bone forming the upper jaw). The fibers run inferiorly and laterally along the sides of the nose and divide into two slips. One slip inserts in the alar cartilage (around nostril) and the other continues down to the upper lip. The muscle elevates the alar cartilages (dilates nostrils) and also elevates the middle part of the upper lip.

The zygomaticus minor originates on the facial surface of zygomatic bone. Running inferiorly and medially, the fibers insert into the modiolus and orbicularis oris, just lateral to the midline. The muscle raises the upper lip for generating the letter “f” along with the muscles that raise the angles of the mouth.

The depressor labii inferioris attaches on the oblique line of mandible near mental foramen. Fibers run superiorly and medially to orbicularis oris and the skin of the lower lip. The muscle draws lower lip downward and laterally, useful in the release of bilabial consonants.

The mentalis originates on the mandible near mental tuberosity (point of the chin). The fibers of the mentalis extend superiorly; some fibers reach orbicularis oris, other fibers insert at different places along the superior extension. When contracted, the mentalis draws the skin on the chin upwards, at the same time everting and protruding the lower lip. In conjunction with orbicularis oris it helps round and protrude the lips for the high rounded vowels “u” and “y.” It also may help to close lips.

The buccinator attaches to the pterygomandibular raphe and lateral surfaces of the mandible and the maxilla (the upper jaw) opposite the molar teeth. The fibers course medially and insert in the modiolus, with some continuing on into the upper and lower lips, forming the more superficial fibers of orbicularis oris. The buccinator draws the lips back against the teeth and pulls the angles of the mouth laterally as an antagonist to the muscles of protrusion and rounding. This action is probably utilized in the production of labiodental and bilabial fricatives. If the lips are actively spread in pronunciation of vowels such as “i” and “e” (which seldom happens), this muscle may be used.

The zygomaticus major muscle attaches on the outer edge of zygomatic bone, just lateral to zygomaticus minor, and may inserts into the more superficial connective tissue that extends to cover the temporalis muscle. The fibers course inferiorly and medially to insert into the modiolus and orbicularis oris of the upper lip. When contracted, the zygomaticus major muscle draws the angle of the mouth upward and laterally. The upward movement may work with the levator anguli oris to rasie the upper lip in labiodental fricatives. Lateral movement of the zygomaticus major muscle may be used in the production of the letter “s.”

The levator anguli oris muscle runs from the canine fossa on the maxilla coursing inferiorly and slightly laterally; most fibers of the levator anguli oris muscle insert in the modiolus, and a few fibers of the levator anguli oris muscle inserting into the lower lip. The levator anguli oris draws the corner of the mouth upwards and, because of the fibers that insert into the lower lip, may assist in closing the mouth by drawing the lower lip up, for the closure phase when producing bilabial consonants.

The depressor anguli oris muscle attaches to the oblique line of mandible, and is superficial and lateral to the depressor labii inferioris. The depressor anguli oris muscle runs vertically upwards, interdigitating with the platysma, and inserts into the modiolus. Some fibers of the depressor anguli oris muscle insert into the upper lip. When contracted, the depressor anguli oris muscle depresses the angles of the lips, for example, to prevent the mouth from completely closing when producing the vowels “i” and “e.” In addition, contraction of the depressor anguli oris muscle may aid in compressing the lips by drawing the upper lip down.

The platysma muscle originates in the fascia covering superior parts of pectoralis major and deltoid muscles. Fibers of the platysma muscle run superiorly and anteriorly. A first set of fibers of the platysma muscle insert into the lower border of the mandible and blend with the depressor labii inferioris and the depressor anguli oris, and a second set of fibers of the platysma muscle turn more medially and insert into the modiolus. Contraction of the platysma muscle may assist the depressor anguli oris and depressor labii inferioris muscles to draw down and laterally the angles of the mouth.

There are a few muscles in the pharynx that may have an influence on tongue position and mandibular movements during speech. These muscles are referred to as pharyngeal constrictors, which include the superior pharyngeal constrictor, the medial pharyngeal constrictor, and the inferior pharyngeal constrictor.

The Superior Pharyngeal Constrictor muscle has several different origins and a comparable number of names: a) Originating at the lower one-third of the medial pterygoid palate and the hamulus is the pterygopharyngeus; b) Originating at the pterygomandibular raphe is the buccopharyngeus; c) From the posterior part of the mylohyoid line and adjacent alveolar process of the mandible is the mylopharyngeus and d) a few fibers from the side of the tongue are sometimes called the glossopharyngeus. All fibers insert into the midline pharyngeal raphe. These muscles narrow the upper wall of the pharynx.

The Medial Pharyngeal Constrictor muscle consists of two minor muscles including the ceratopharyngeus muscle chondropharyngeus muscle. The ceratopharyngeus muscle originates on the superior border of the greater horn of the hyoid bone and the stylohyoid ligament. The chondropharyngeus muscle includes fibers that extend superiorly and medially to the medial pharyngeal raphe—the superior fibers overlap the fibers of the superior constrictor and contract the pharynx during swallowing.

The part of the inferior pharyngeal constrictor that arises from the thyroid lamina and the superior cornu of the thyroid cartilage and inserts into the pharyngeal raphe is commonly referred to as the thyropharyngeus. Fibers arising from the cricoid cartilage and the inferior cornu of the thyroid cartilage are commonly referred to as the cricopharyngeus. The inferior-most fibers extend obliquely downward to blend with the muscle fibers of the esophagus and form a sphincter. The Cricopharyngeus becomes a pseudo-glottis in laryngectomized patients; it sets the aperture of the esophagus for esophageal speech. From a fixed larynx, the inferior constrictor can constrict the lower part of the pharynx for swallowing.

There are a plurality of extrinsic muscles of the larynx which act as elevators or depressor thereby potentially having an influence on tongue position and mandibular motion during speech. The muscles that act as elevators are the anterior belly of the digastric muscle, the posterior belly of the digastric muscle, the Genioglossus muscle, the Geniohyoid, the Hyoglossus muscle, the Mylohyoid muscle, the medial pharyngeal constrictor, and the stylohyoid muscle. The muscles that act as depressors are the omohyoid muscle, the sternohyoid muscle, the sternothyroid muscle, and the thyrohyoid muscle.

The posterior belly portion of the digastric muscle attaches to the mastoid process of the temporal bone, and includes fibers that extend inferiorly and anteriorly to meet the anterior belly at an intermediate tendon. The posterior belly of the digastric draws the hyoid bone superiorly and posteriorly and with it the larynx. Contraction of the posterior belly of the digastric may also help bring the tongue into position for velar articulations.

The Stylohyoid muscle originates on the styloid process on the temporal bone. The fibers course inferiorly and anteriorly to insert in the greater cornu of the hyoid bone. It works with the posterior belly of the digastric to elevate and draw posteriorly the hyoid and with it the larynx. Because the fibers are attached to the greater cornu of the hyoid bone, contraction will cause the hyoid bone and the thyroid cartilage to tilt forward when the sternohyoid muscle acts as a fixator. This may help bring the tongue forward for alveolar, dental and interdental articulations.

The Omohyoid muscle's posterior belly originates on the upper border of the scapula, anterior belly on the intermediate tendon. The posterior belly inserts in the intermediate tendon, where the anterior belly takes over and runs vertically and slightly medially to the lower border of the greater cornu of the hyoid bone. The omohyoid lowers the hyoid and the larynx, similar to the sternohyoid muscle.

The Sternohyoid muscle attaches to the posterior surface of the manubrium of the sternum and the medial end of the clavicle. Fibers of the Sternohyoid muscle run vertically to the lower border of the body of the hyoid bone. The sternohyoid muscle draws the hyoid bone inferiorly, which pulls the larynx forward, lowering F0 by increasing the superior-inferior thickness of the vocal folds. The Sternohyoid muscle also may tilt down the anterior part of the hyoid bone for front articulations.

The Sternothyroid muscle attaches to the posterior surface of the manubrium of the sternum and the first costal cartilage. The fibers of the Sternothyroid muscle extend superiorly and slightly laterally, inserting in the oblique line on the thyroid cartilage. The function of this muscle is under some dispute. Some investigators call it a hyoid depressor, others a larynx elevator, with some fibers also serving to stabilize, or perhaps raise, the thyroid cartilage.

The Thyrohyoid muscle attaches to the oblique line of thyroid cartilage. The Thyrohyoid muscle runs vertically, deep to the omohyoid and the sternohyoid muscle and inserts in the lower border of the greater cornu of the hyoid bone. When contracted, the Thyrohyoid muscle decreases the distance between the thyroid cartilage and the hyoid bone. When the thyroid cartilage is fixed, it depresses the hyoid bone. When the hyoid bone is fixed, it elevates the thyroid cartilage and raises the pitch. Thyrohyoid muscle also may tilts the hyoid backwards, which may be appropriate for velar and uvular articulations.

### Interpreting Speech Based on Obtained Signals

When a person speaks, muscles associated with the person's upper airway are engaged by commands from the brain to enable production of audible sounds (such as by using air pressure). As used herein, the term “muscles associated with the person's upper airway” may refer to or include any number of any combination of the muscles described above with respect to FIGS. 1A and 1B that may be associated or involved with the generation of oral-based communications of a person—including audible speech, inaudible speech, and silent speech. During production of these audible sounds, the muscles associated with the person's upper airway move and generate small neural impulses associated with the sounds being produced. Even when a person is speaking in a sub-audible manner, or speaking silently, these muscles still respond with such neural impulses, although at a lower level. The movement of muscles associated with the person's upper airway when a person speaks may exhibit electrical activity. The level of electrical activity may be related to the (such as proportional to) to the level or amount of muscle movement.

In accordance with aspects of the present disclosure, communication devices disclosed herein may sense (or obtain signals indicative of) activity within or associated with the person's oral cavity and upper airway to detect a presence of speech and to interpret communications associated with such speech. As mentioned above, the term “activity” may refer to electrical activity, neural activity, muscle movement, or any combination thereof, and the terms “oral-based communications” and “communications” may refer to audible speech, in-audible speech, whispering, and “mouthing” words or symbols using one or more portions of the persons mouth or oral cavity. For example, when a person generates oral-based communications using the musculature of the oral cavity, the communication devices disclosed herein may obtain one or more signals indicative of activity in the oral cavity, and then interpret the oral-based communications based on the one or more obtained signals.

The communication device may include a plurality of contacts configured to obtain signals associated with various numbers and combinations of the muscles and tissues associated with the person's upper airway (or alternately to obtain signals associated with one or more groups of muscles and tissues of the person's oral cavity). In some implementations, each of the plurality of contacts may obtain one or more signals indicative of electrical or neural activity of a corresponding set of muscles. The set of muscles corresponding to a given contact may be based at least in part on the position of the given contact in the person's oral cavity, for example, so that the contact can obtain one or more signals indicative of activity associated with the set of muscles. Thus, in some aspects, the specific muscle or group of muscles from which each of the plurality of contacts may obtain signals may be changed by adjusting the locations of the plurality of contacts within the person's oral cavity.

In some implementations, the communication device may combine the signals obtained by each of the plurality of contacts to generate a composite signal. The composite signal may represent the activity of a greater portion of the person's oral cavity than the signals provided any one of the contacts. The signals obtained by each of the plurality of contacts may be combined in any suitable manner to generate the composite signal. For example, the signals obtained from the contacts may be summed, averaged, integrated, correlated, or any combination thereof to generate the composite signal. In some aspects, one or more of the signals obtained by each of the plurality of contacts may be weighted (such as by using a number of suitable weighting values) when generating composite signal, for example, so that the communication device may dynamically adjust the relative effect of signals provided by different contacts upon the composite signal. Further, because the specific muscle or group of muscles from which each of the plurality of contacts may obtain signals may be based on the locations of the contacts within the person's oral cavity, different positions and configurations of the plurality of contacts may result in the generation of different composite signals. Accordingly, in some aspects, the communication device may generate a composite signal for each of a number of sets of positions of the contacts within the person's oral cavity.

The resulting composite signal may be compared with a number of reference signals to determine a letter, number, word, phrase, or sentence “spoken” by the person. The reference signals, which each may be associated with a corresponding one of a plurality of different oral-based communications provided by the person, may be obtained from the plurality of contacts at a number of different times. In some implementations, the reference signals may be generated during a calibration or learning phase of the communication device, for example, to determine a number of baseline waveforms or reference signals. If there is a match between the composite signal and the number of reference signals, then the communication device may determine that the oral-based communication associated with the composite signal is the same as the oral-based communication associated with the matching reference signals.

The composite signal may be compared with the number of reference signals using suitable signal comparison or correlation technique. In some aspects, the composite signal may be compared with each of the number of reference signals on a point-by-point basis (on a per-sample basis) using a minimum mean squared error (MMSE) detector, for example, to determine a degree of correlation between the composite signal and each of the reference signals. If the difference value provided by the MMSE detector is less than (or equal to) than a threshold value, then the communication device may determine a match between the composite signal and the matching reference signals. In other aspects, a covariance matrix may be used to determine a degree of correlation between the composite signal and each of the number of reference signals. If the resulting covariance is less than (or equal to) than a threshold value, then the communication device may determine a match between the composite signal and the matching reference signals.

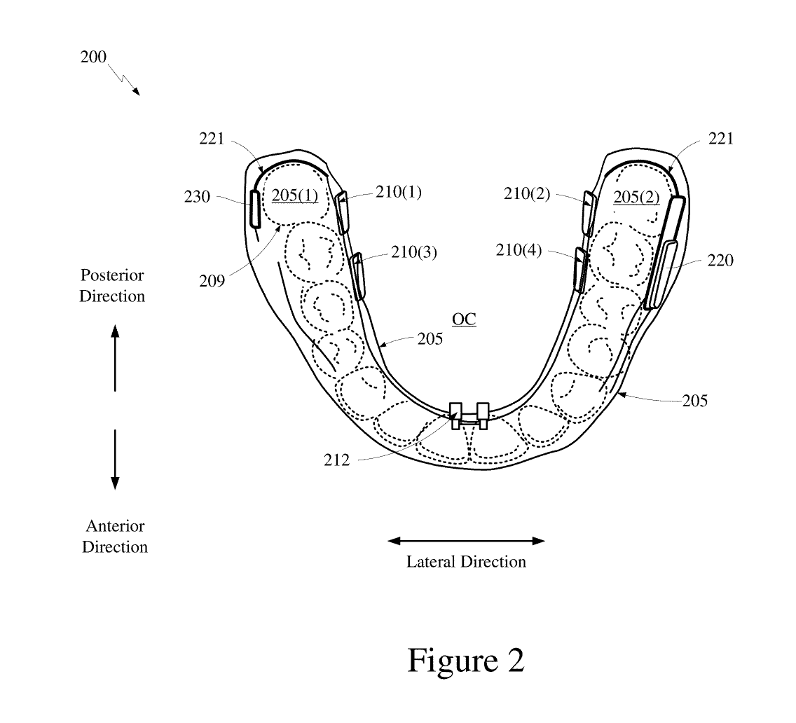

FIG. 2 shows a communication device 200 in accordance with various aspects of the present disclosure. In some implementations, the communication device 200 may be used to detect and interpret speech based on signals indicative of one or more activities in or associated with a person's oral cavity. In some aspects, the communication device 200 may be a removable intra-oral appliance (such as a dental retainer) that can be inserted and removed from a person's oral cavity. In other aspects, the communication device 200 may include one or more components that extend from, or are located external to, the person's oral cavity.

For the example of FIG. 2, the communication device 200 is shown to include an appliance 205 upon which a number of contacts 210(1)-210(4), one or more sensors 212, a control circuit 220, and a power source 230 may be mounted (or otherwise attached to). In some implementations, the communication device 200 may be a unitary and removable device adapted to fit entirely within a person's oral cavity OC (see also FIG. 1A), for example, such that there are no components external to the person's body. In some aspects, the appliance 205 may be adapted to fit over a person's lower teeth so as to be positioned within a sublingual portion of the person's oral cavity OC, for example, as depicted in FIG. 2. In other aspects, the appliance 205 may be adapted to fit over a person's upper teeth so as to be positioned within an upper portion of the person's oral cavity oral cavity (not shown for simplicity). In some other aspects, the communication device 200 may be of other suitable configurations or structures.

The appliance 205 may include one or more conductive wires or traces 221 that electrically couple the contacts 210(1)-210(4) and the sensors 212 to the control circuit 220. The wires 221 also may couple the control circuit 220 to the power source 230. In some implementations, the wires 221 may be positioned either within or on an outside surface of the appliance 205, and therefore do not protrude into or otherwise contact the person's tongue or oral tissue. The power source 230 may be mounted in any of several locations on the appliance 205 and may be any suitable power supply (such as a battery) that provides power to the control circuit 220. In some aspects, active functions of the contacts 210(1)-210(4) may be controlled using bi-directional gating techniques that regulate the voltages and/or currents within the wires 221. For one example, in a sensing mode, the wires 221 may route signals detected or obtained by the contacts 210(1)-210(4) to the control circuit control circuit 220. For another example, in a therapeutic mode, the wires 221 may deliver stimulation waveforms to the contacts 210(1)-210(4), which in turn may provide electrical stimulation to one or more portions of the person's upper airway (such as to reduce apnea or snoring).

The contacts 210(1)-210(4) may be arranged or positioned in any suitable manner that allows the contacts 210(1)-210(4) to detect and measure the electrical activity of muscles and tissue associated with the person's upper airway and/or to detect and measure the movement of muscles associated with the person's upper airway. In some aspects, each of the contacts 210(1)-210(4) may be positioned, with respect to one or more anatomical structures of the person's oral cavity, to detect electrical activity from a specific muscle. For one example, a first set of contacts 210(1) and 210(2) may be positioned to obtain one or more signals indicative of activity of the person's Palatoglossus muscle, while a second set of contacts 210(3) and 210(4) may be positioned to obtain one or more signals indicative of activity of the person's inferior longitudinal muscle. In other implementations, the contacts 210(1)-210(4) may be located in other suitable positions within the person's oral cavity. It is noted that although only four contacts 210(1)-210(4) are shown in the example of FIG. 2, in other implementations, the communication device 200 may include a greater number of contacts or a fewer number of contacts 210.

In at least some implementations, each of the contacts 210(1)-210(4) may be selectively turned on or off independently of the other contacts 210 by the control circuit 220. The ability to individually turn any one or more of the contacts 210(1)-210(4) on or off may allow the communication device 200 to identify specific positions of the 210(1)-210(4) and/or specific combinations of the contacts 210(1)-210(4) that result in an optimum level of electrical activity detection. For example, during a testing phase, the control circuit 220 may selectively enable different combinations of the contacts 210(1)-210(4) and determine which of the combinations provides the best (such as the clearest or the most accurate) signals from which the person's communications may be interpreted.

The contacts 210(1)-210(4) may be formed using any suitable material, and may be of any suitable size and shape suitable for obtaining signals indicative of electrical activity of muscles and tissue associated with the person's oral cavity. In addition, the contacts 210(1)-210(4) may each correspond to an array of contacts.

In some implementations, the contacts 210(1)-210(4) may be configured to determine when a person has started and stopped engaging in oral-based communications (such as speaking) For example, the contacts 210(1)-210(4) may wait for a signal or indicator to begin obtaining signals indicative of speech, for example, to minimize power consumption. Similarly, the contacts 210(1)-210(4) may be configured to detect a signal or indicator to stop obtaining signals indicative of speech.

The sensors 212 may be any suitable sensors capable of detecting a characteristic or attribute of the person. In some implementations, the sensors 212 may be one of including at least of an Sp02 sensor, a temperature sensor, an accelerometer, a heart rate signal sensor, and a blood pressure sensor.

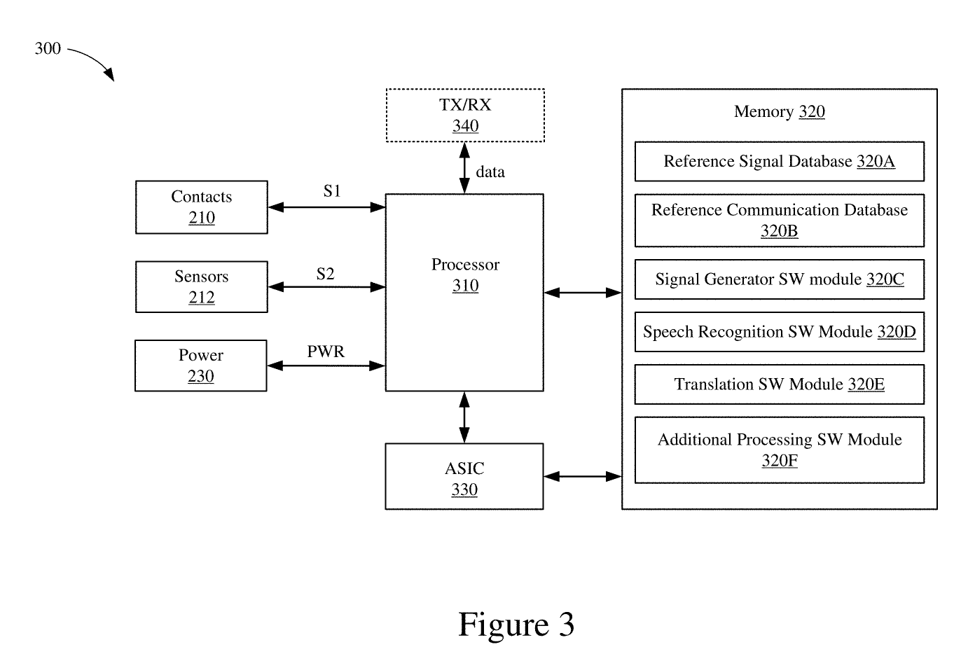

FIG. 3 shows a block diagram of a control circuit 300 that may be one implementation of the control circuit 220 of FIG. 2. The control circuit 300 is shown to include a processor 310, a memory 320, an ASIC 330, and an optional transceiver 340. The processor 310, which may be any one or more suitable processors capable of executing scripts or instructions (such as software programs stored in the memory 320), may be coupled to the memory 320, the ASIC 330, and the transceiver 340. The processor 310 is also depicted as being coupled to a plurality of contacts 210(1)-210(n), the sensors 212, and the power supply 230 of the communication device 200 of FIG. 2. In some implementations, the processor 310 may control the power supply 230 using a power control signal PWR. For one example, the processor 310 may instruct the power supply 230 to selectively provide power to the contacts 210(1)-210(n) only for periods of time for which the contacts 210(1)-210(n) are to be active (such as providing electrical stimulation to the person's upper airway). In this manner, power consumption of the control circuit 300 may be reduced, and the transmission of electrical signals on wires 221 (see also FIG. 2) may be reduced.

The memory 320, which may be any suitable type of memory or storage device, may store data to be transmitted from the communication device 200, may store data received from other devices, and may store other suitable information for facilitating the operation of the communication device 200. The memory 320 may include a reference signal database 320A that stores a number of reference signals associated with a number of letters, numbers, words, phrases, and/or sentences. In some aspects, the reference signal database 320A may store a set of reference signals for each of a number of reference letters, numbers, words, phrases, and/or sentences. In some aspects, the reference letters, numbers, words, phrases, and/or sentences may be stored in the reference signal database 320A. In other aspects, the reference letters, numbers, words, phrases, and/or sentences may be stored in a reference communications database 320B. A reference signal determined to match a composite signal based on one or more signals obtained from the contacts 210 may be used as a look-up key or value to retrieve the corresponding letter, number, word, phrase, or sentence from the reference communications database 320B.

The reference signals may be obtained, generated, or otherwise determined in one or more previous time periods to establish a baseline or reference signal for each of a number of letter, number, word, phrase, or sentence for each person. For example, during a calibration phase, a person may be given a number of “test” letters, numbers, words, phrases, and/or sentences to communicate, and the communication device 200 may obtain a set of one or more signals indicative of upper airway and/or oral cavity activity associated with the person's communication of a corresponding one of the “test” letters, numbers, words, phrases, and/or sentences.

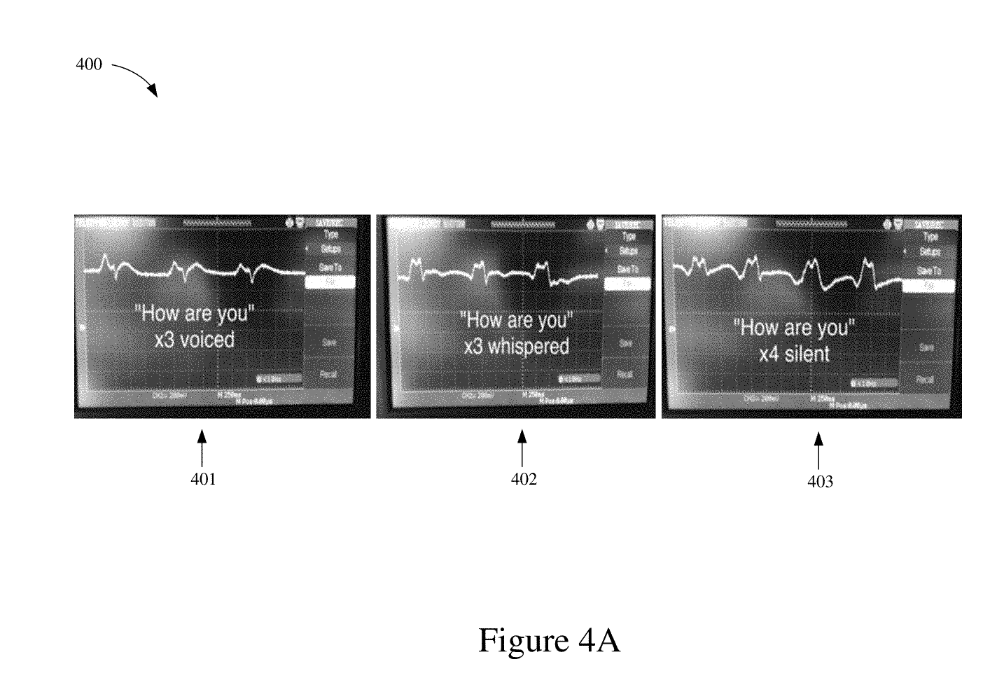

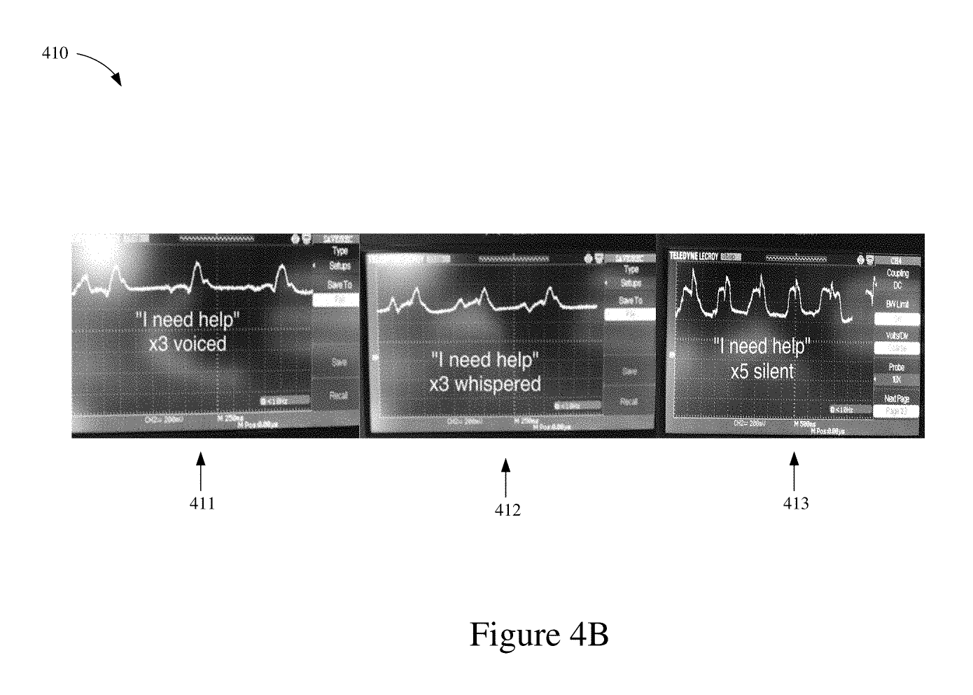

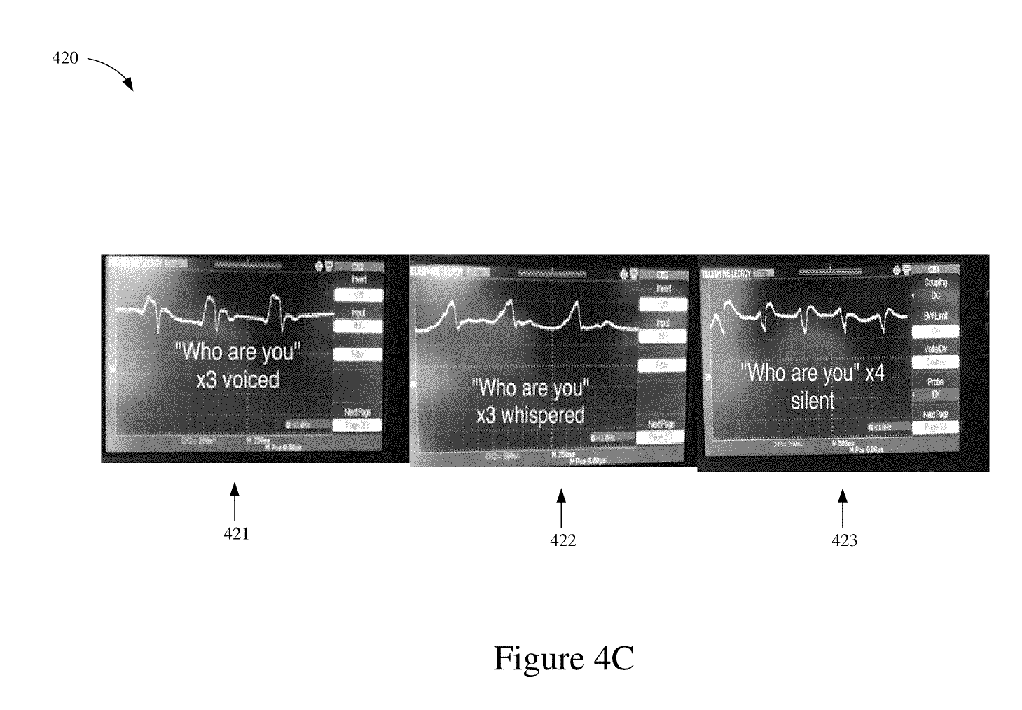

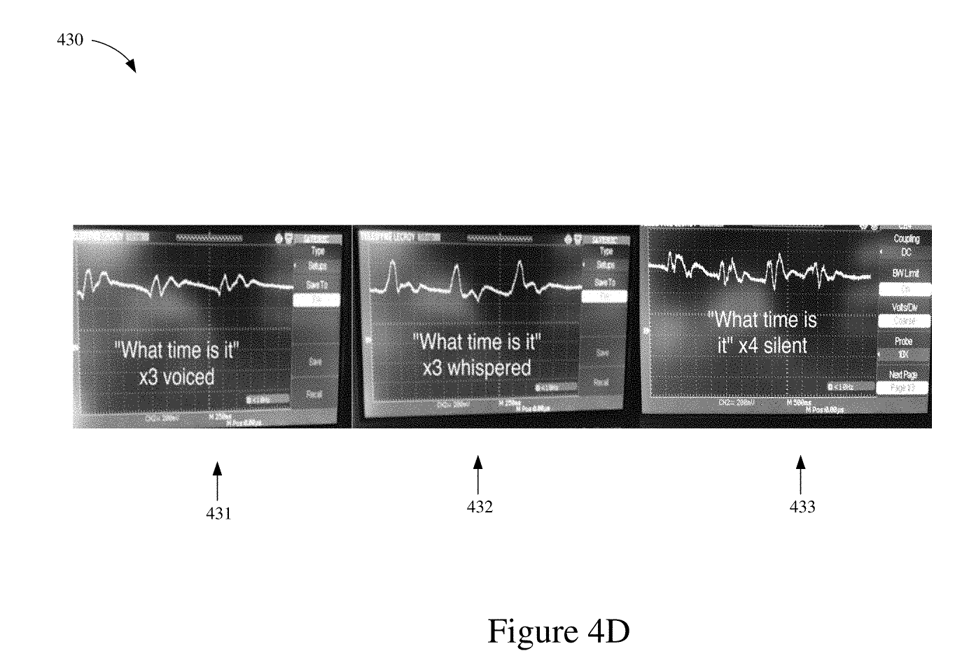

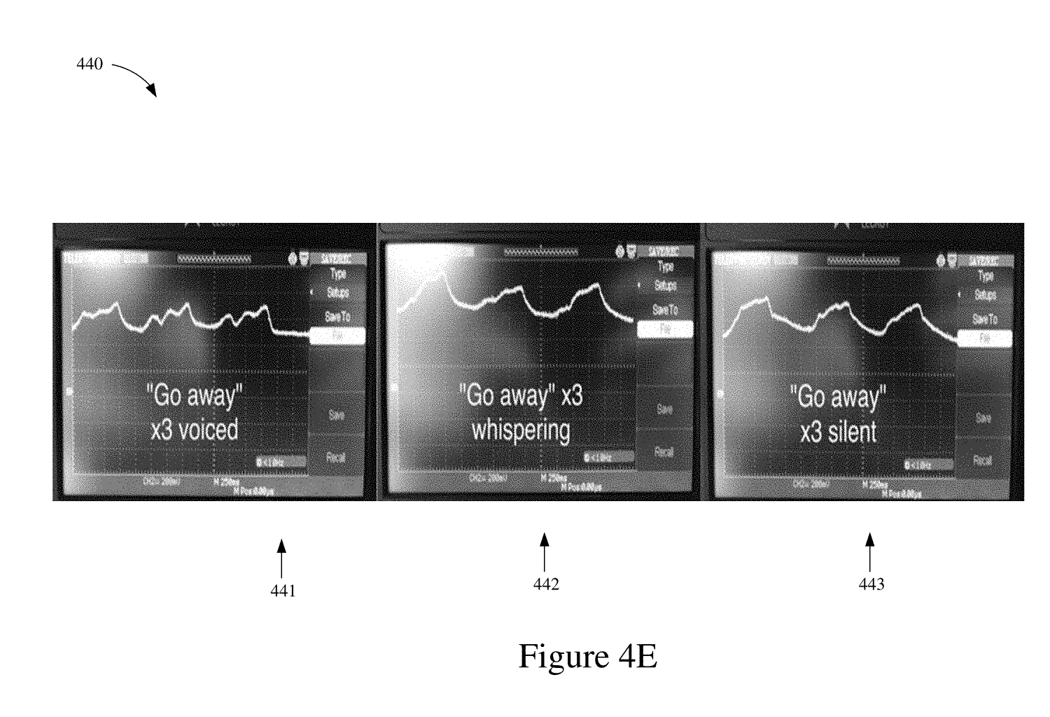

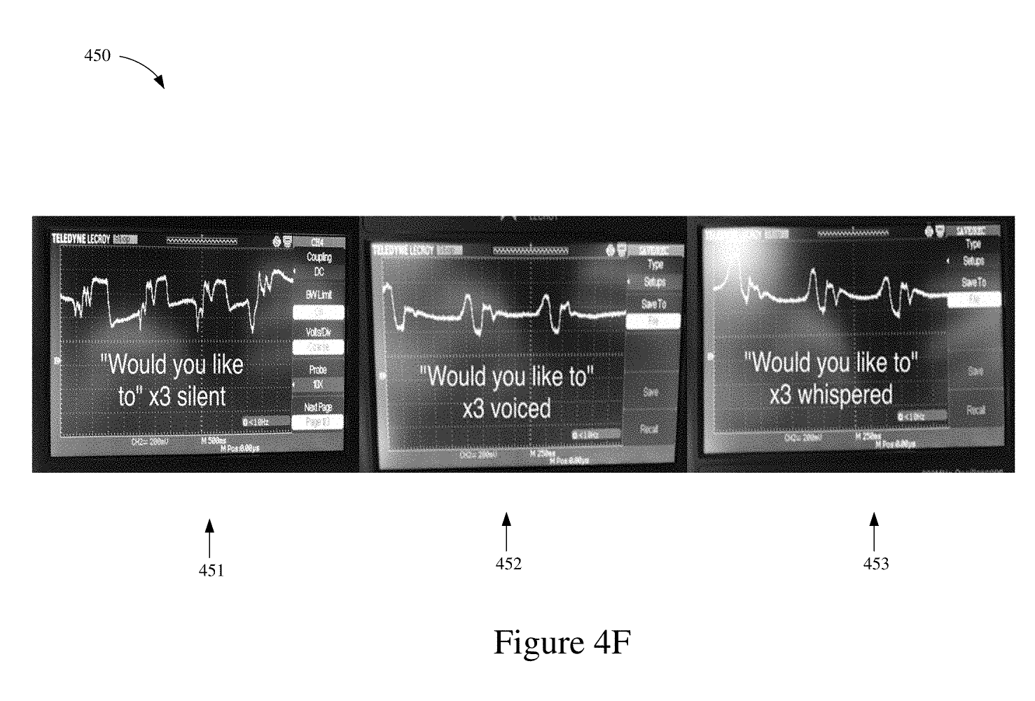

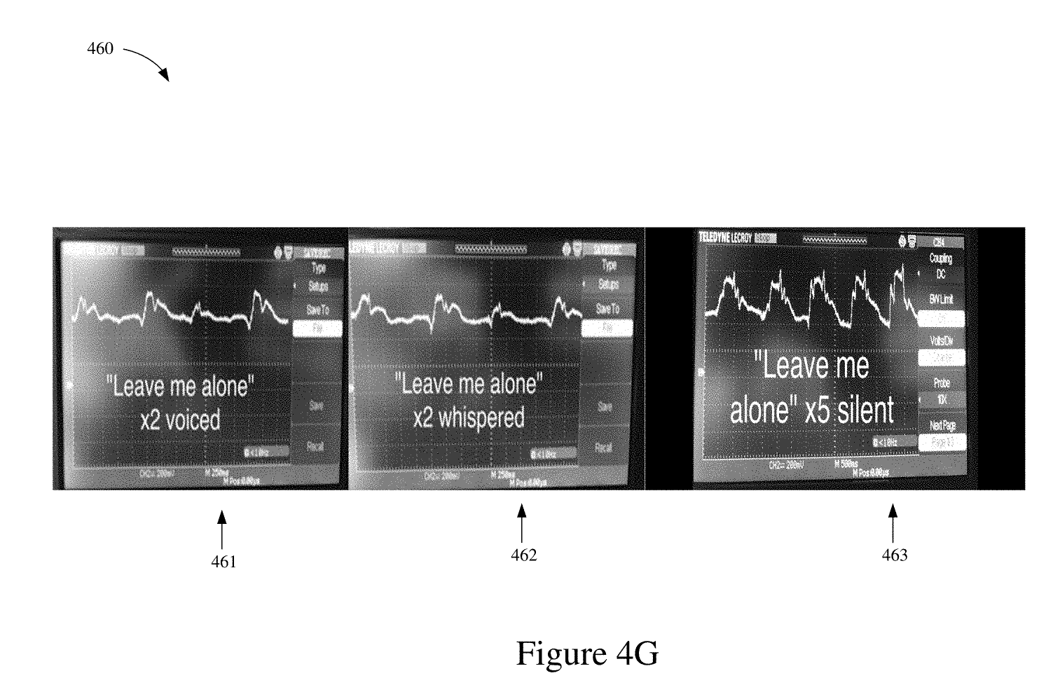

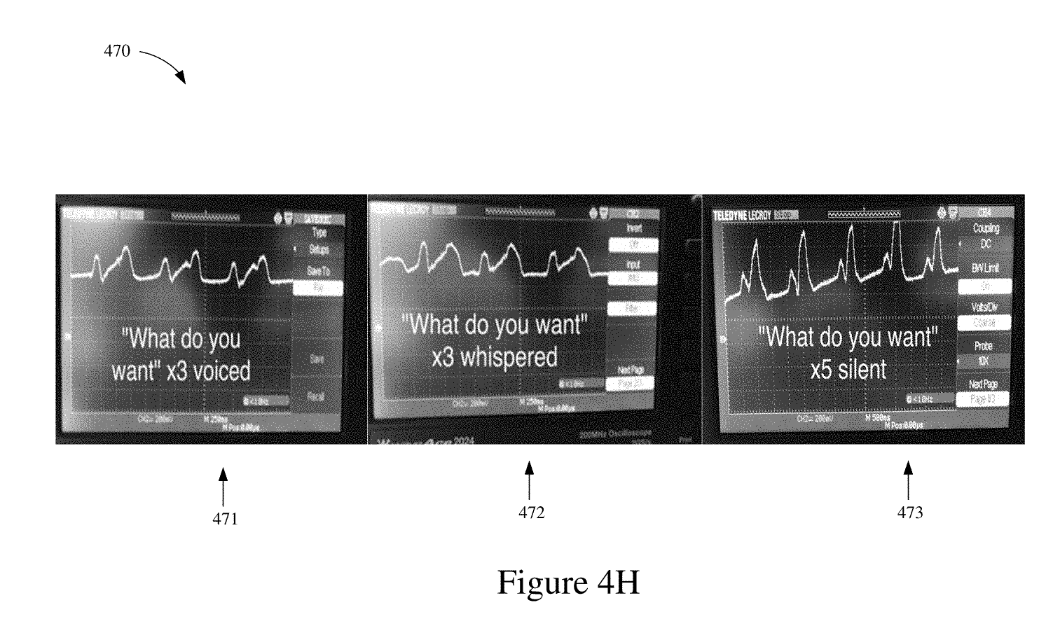

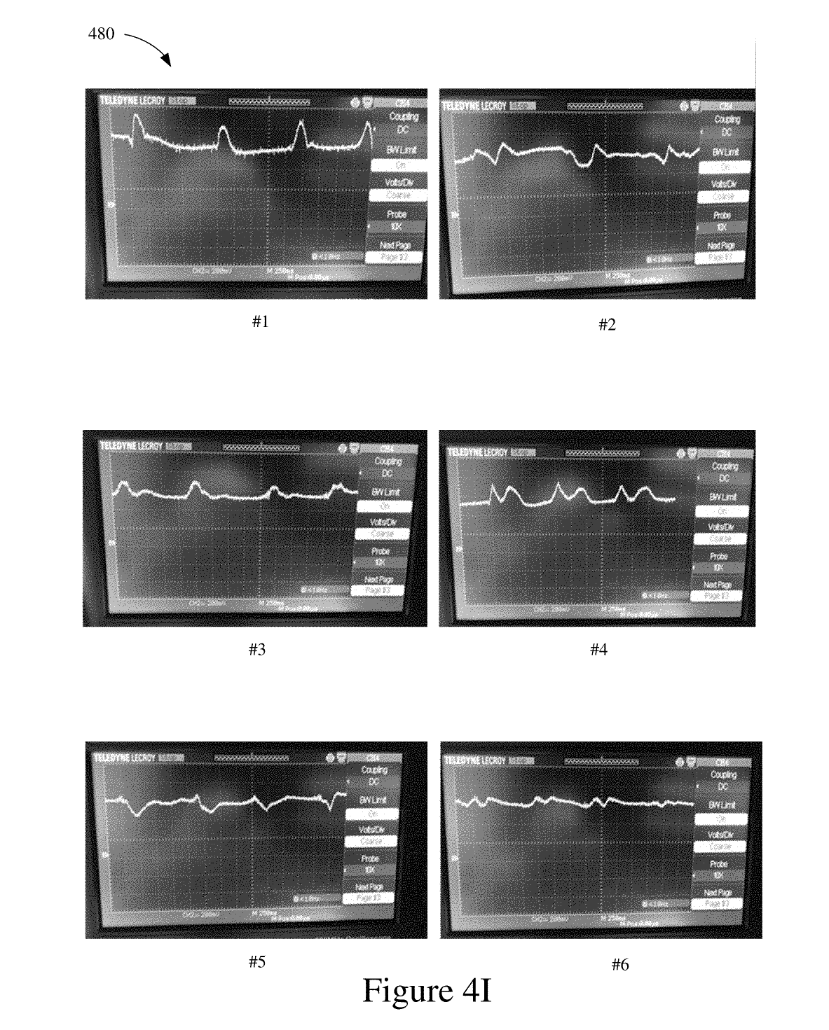

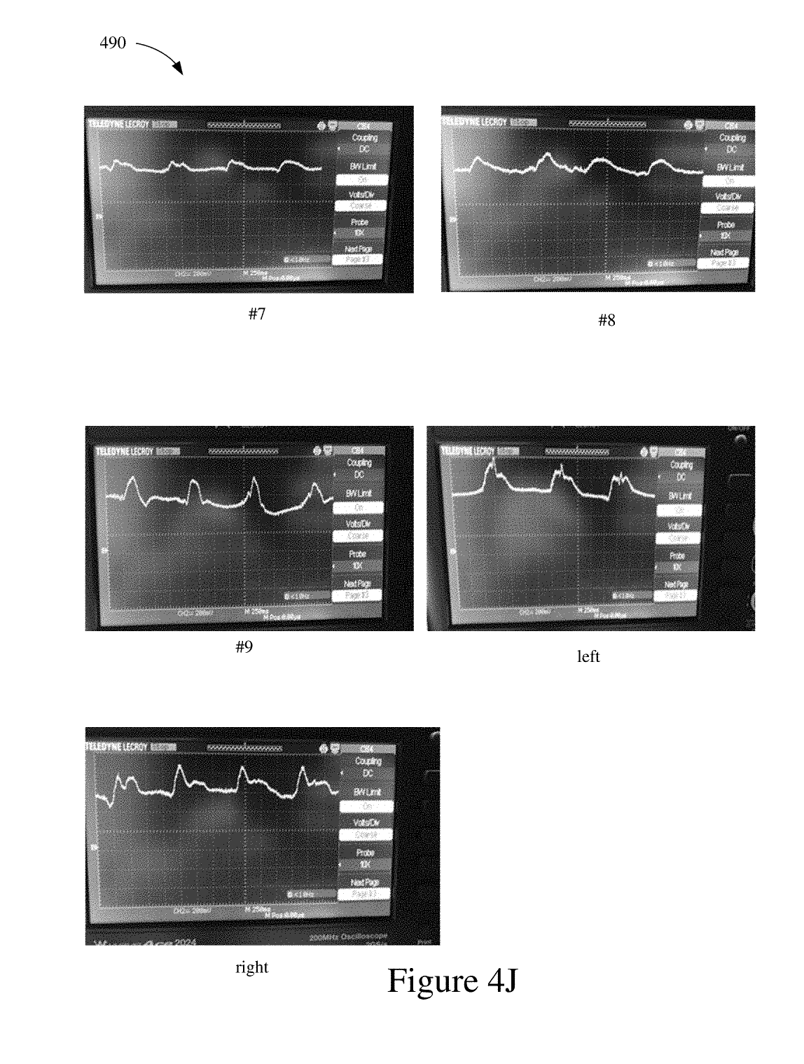

In some implementations, the reference signals may be obtained from the person intended to use the communication device 200. More specifically, prior to a person's use of the communication device 200, the person may cause the communication device 200 to enter a calibration (or learning) phase during which the communication device 200 may generate and store a number of reference signals based on the person communicating a set of test letters, numbers, words, phrases, and/or sentences. In some aspects, the person may communicate each set of test letters, numbers, words, phrases, and/or sentences using different communication modes. For example, while the person first communicates the test phrase “how are you” in a normal voice (such as audible speech), the communication device 200 may obtain one or more signals indicative of activity in the person's upper airway and store the obtained signals as a first reference signal (such as the signal 401 of FIG. 4A). Next, while the person communicates the test phrase “how are you” in a whispered voice, the communication device 200 may obtain one or more signals indicative of activity in the person's upper airway and store the obtained signals as a second reference signal (such as the signal 402 of FIG. 4A). Then, while the person communicates the test phrase “how are you” in a silent voice (such as inaudible speech), the communication device 200 may obtain one or more signals indicative of activity in the person's upper airway and store the obtained signals as a third reference signal (such as the signal 403 of FIG. 4A).

In other implementations, the reference signals may be obtained from another person (or an automated voice system) prior to use of the communication device 200 by the intended user. For example, during the calibration phase, the communication device 200 may generate and store a number of reference signals based on a reference person communicating a set of test letters, numbers, words, phrases, and/or sentences. The communication device 200 may obtain and store a set of reference signals for each of a multitude of test letters, numbers, words, phrases, and/or sentences in a manner similar to that described above with respect to the intended user, except that the reference person may be used to generate and store a number of reference signals for a plurality of communication devices 200 (such as before the communication devices 200 are sold or otherwise made available to users).

The memory 320 may be or include a non-transitory computer readable medium that may store one or more of the following programs or software (SW) modules:
a signal generator SW module 320C to obtain, from the contacts 210, one or more signals indicative of activity in a person's upper airway while the person is engaging in oral-based communications;
a speech recognition SW module 320D to interpret the oral-based communications based on the signals obtained by one or more of the contacts 210 or based on a composite signal;
a translation SW module 320E to translate the interpreted communications into one or more selected languages; and
an additional processing SW module 320F to selectively provide additional signal processing to the signals obtained by the contacts 210.

The processor 310 may execute the signal generator SW module 320C to obtain, from the contacts 210, one or more signals indicative of activity in a person's upper airway when the person is engaging in oral-based communications. In some aspects, the processor 310 may execute the signal generator SW module 320C to generate a composite signal based on one or more of the signals obtained by the contacts. Because the composite signal may be based on a plurality of the signals obtained by the contacts 210, the composite signal may be indicative of activity in a larger and/or more diverse portion of the person's oral cavity or upper airway than the signals obtained from any particular one of the contacts 210.

The processor 310 may execute the speech recognition SW module 320D to interpret the oral-based communications based on the obtained signals or the composite signal. In some aspects, the speech recognition SW module 320D may compare the obtained signals with a number of the reference signals stored in the reference signal database 320A to interpret the person's oral-based communications. In other aspects, the speech recognition SW module 320D may compare the composite signal with a number of the reference signals stored in the reference signal database 320A to interpret the person's oral-based communications.

The processor 310 may execute the translation SW module 320E to translate the interpreted communications into one or more selected languages. In some implementations, the processor 310 may execute the translation SW module 320E to perform simultaneous translation, for example, so that a person may select a target language, and then “speak” silently while the communication device 200 is active. In response thereto, the communication device 200 may detect the words or phrases “spoken” by the person, translate the interpreted communication into the target language, and then transmit the translated communication to another device (such as using Bluetooth or Wi-Fi signals). In some aspects, the communication device 200 also may play the translated communication back to the person, for example, so that the person can use the communication device 200 as a translator.

The processor 310 may execute the additional processing SW module 320F to selectively provide additional signal processing to the signals obtained by the contacts 210. The ASIC 330 may include one or more ASICs or other suitable hardware components (such as FPGAs) that can perform the functions of one or more of the SW modules stored in the memory 320. In some implementations, the ASIC 330 may include or perform the functions of a MMSE detector, for example, to determine a degree of correlation between the composite signal and each of the reference signals. In addition, or in the alternative, the ASIC 330 may include or perform the functions of a covariance matrix, for example, to determine a degree of correlation between the composite signal and each of the reference signals.

The control circuit 300 may provide the interpreted communication to the transceiver 340, which in turn may transmit the interpreted communication to a remote device (or multiple remote devices). In this manner, a user of the communication device 200 may transmit oral-based communications to one or more other devices using audible speech, inaudible speech, or silent speech. In some aspects, the remote device may be another communication device that provides the interpreted communication to user of the remote device. In other aspects, the remote device may be configured to receive the interpreted communication as a command to perform some action.

Referring also to FIG. 2, in some implementations, each of the contacts 210 may be configured to detect activity of a corresponding muscle and to obtain or generate a signal indicating the activity of the corresponding muscle. The control circuit 300 may receive signals obtained by the contacts 210, and may perform preprocessing on each signal depending on which contact the signal originated from. For one example, a first of the contacts 210 may be configured to detect electrical activity associated with the tongue, and may provide a signal indicating electrical activity of the tongue. Upon receiving the signal from the first contact, the control circuit 300 may perform preprocessing unique to signals received from the first contact prior to generating the composite signal. In some aspects, the memory 320 may store data indicating which muscles control certain aspects of speech, and select additional processing to be performed on signals corresponding to those muscles. By way of example only, such data may indicate that the tongue controls enunciation of certain letters, and the inflection of words beginning with or including those letters. Thus, upon receiving signals from the contact 210(1), the control circuit 220 may refer to the data in memory to determine the additional processing required to emphasize those aspects of speech and apply the additional processing to the received signals. By individually processing the signals received from each of the contacts 210 based on their associated muscles, the composite signal generated by the control circuit 300 may more accurately capture the person's communications.

The communication device 200 may use also biometric identification to determine the identity of a person that is currently using the communication device 200 and determine whether the person is an authorized user. For example, the communication device 200 may analyze the signal characteristics and patterns of the person speaking, and compare them to the stored signal characteristics and patterns of authorized persons to determine if the person is authorized. If an unauthorized person is detected, the communication device 200 may deactivate, or produce an electrical signal via the contacts 210 to cause discomfort to the unauthorized person.

In addition, or as an alternative, the communication device 200 may also determine whether a person is telling the truth or lying by analyzing signal characteristics and patterns of the person's speech and detecting certain characteristics or patterns that are indicative of lying.

Referring also to FIG. 2, when a person using the communication device 200 communicates, the contacts 210 may obtain signals indicative of electrical activity in one or more muscles and tissues in the person's upper airway, and provide the obtained signals to the control circuit 300. In some implementations, the contacts 210 may detect electrical activity of one or more individual muscles of the person's tongue. For example, movements of the tongue (such as contractions, expansions, vibrations, and so on) may correspond to movements of one or more muscles in the upper airway of the person. The control circuit 300 may superimpose signals obtained by the contacts 210 to generate a composite signal. In some implementations, the control circuit 300 may perform additional signal processing on the composite signal. For one example, the processor 310 may execute the additional processing SW module 320F to perform amplification, analog to digital conversion, rectification, filtering, integration, and/or calculating the mean of the composite signal. For another example, the processor 310 may execute the additional processing SW module 320F to generate a Fast Fourier Transform (FFT) function of the composite signal.

The control circuit 300 may compare the obtained signals (or the composite signal) with the reference signals stored in the reference signal database 320A to determine whether a match exists. If the obtained signals (or the composite signal) matches one of the reference signals, then the control circuit 300 may determine that the person's communication is the letter, number, word, phrase, and/or sentence associated with the matching reference signal. In some aspects, the control circuit 300 may determine a match with a given reference signal if the deviation between the obtained signal and the given reference signal less than or equal to a threshold. The threshold may be based on a deviance in amplitude, frequency, period, or any combination thereof. If multiple reference signals qualify as a match based on their corresponding deviations being less than the threshold, then the control circuit 300 may select the reference signal having the lowest deviation as the matching reference signals.

In some aspects, the control circuit 300 may perform voice mutation, for example, by changing one or more parameters of the signals corresponding to the interpreted communication. In this manner, the control circuit 300 to mask the identity of the origin or identity of the person responsible for the communication.

By using the signals obtained by one or more of the contacts 210 to interpret the person's communication, the communication device 200 is agnostic to whether the person is speaking normally, whispering, speaking silently, or speaking silently while their jaw is stationary, for example, because the control circuit 300 uses unique characteristics of the signals obtained by the contacts 210 to interpret the communications of the person. For example, obtained signals indicative of audible communications may have relatively high amplitudes and relatively steep slopes because use of the pharynx during speech (for loudness) tends to amplify the net movement of the tongue. In contrast, obtained signals indicative of inaudible or silent communications may have relatively low amplitudes and relatively lax slopes, for example, based on a reduced level of involvement of the pharynx (which in turn correlates to less tongue movement). Thus, in some aspects, the level of intensity (power) may be indicated by the sharpness of curves and amplitude, while the speed of speech may be indicated by the frequency (energy).

FIG. 4A is an illustration 400 of signal waveforms indicative of a first phrase detected by the communication device of FIG. 2. More specifically, the illustration 400 shows a first signal waveform 401indicative of a person speaking the phrase “how are you,” shows a second signal waveform 402 indicative of the person whispering the phrase “how are you,” and shows a third signal waveform 403 indicative of a person silently speaking (such as mouthing) the phrase “how are you.”

FIG. 4B is an illustration 410 of signal waveforms indicative of a second phrase detected by the communication device of FIG. 2. More specifically, the illustration 400 shows a first signal waveform 411 indicative of a person speaking the phrase “I need help,” shows a second signal waveform 412 indicative of the person whispering the phrase “I need help,” and shows a third signal waveform 413 indicative of a person silently speaking (such as mouthing) the phrase “I need help.”

FIG. 4C is an illustration 420 of signal waveforms indicative of a third phrase detected by the communication device of FIG. 2. More specifically, the illustration 420 shows a first signal waveform 421 indicative of a person speaking the phrase “who are you,” shows a second signal waveform 422 indicative of the person whispering the phrase “who are you,” and shows a third signal waveform 423 indicative of a person silently speaking (such as mouthing) the phrase “who are you.”

FIG. 4D is an illustration 430 of signal waveforms indicative of a fourth phrase detected by the communication device of FIG. 2. More specifically, the illustration 430 shows a first signal waveform 431 indicative of a person speaking the phrase “what time is it,” shows a second signal waveform 432 indicative of the person whispering the phrase “what time is it,” and shows a third signal waveform 433 indicative of a person silently speaking (such as mouthing) the phrase “what time is it.”

FIG. 4E is an illustration 440 of signal waveforms indicative of a fifth phrase detected by the communication device of FIG. 2. More specifically, the illustration 440 shows a first signal waveform 441 indicative of a person speaking the phrase “go away,” shows a second signal waveform 442 indicative of the person whispering the phrase “go away,” and shows a third signal waveform 443 indicative of a person silently speaking (such as mouthing) the phrase “go away.”

FIG. 4F is an illustration 450 of signal waveforms indicative of a sixth phrase detected by the communication device of FIG. 2. More specifically, the illustration 450 shows a first signal waveform 451 indicative of a person speaking the phrase “would you like to,” shows a second signal waveform 452 indicative of the person whispering the phrase “would you like to,” and shows a third signal waveform 453 indicative of a person silently speaking (such as mouthing) the phrase “would you like to.”

FIG. 4G is an illustration 460 of signal waveforms indicative of a seventh phrase detected by the communication device of FIG. 2. More specifically, the illustration 460 shows a first signal waveform 461 indicative of a person speaking the phrase “leave me alone,” shows a second signal waveform 462 indicative of the person whispering the phrase “leave me alone,” and shows a third signal waveform 463 indicative of a person silently speaking (such as mouthing) the phrase “leave me alone.”

FIG. 4H is an illustration 470 of signal waveforms indicative of an eighth phrase detected by the communication device of FIG. 2. More specifically, the illustration 470 shows a first signal waveform 471 indicative of a person speaking the phrase “what do you want,” shows a second signal waveform 472 indicative of the person whispering the phrase “what do you want,” and shows a third signal waveform 473 indicative of a person silently speaking (such as mouthing) the phrase “what do you want.”

FIG. 4I is an illustration 480 of signal waveforms indicative of various numbers detected by the communication device of FIG. 2. More specifically, the illustration 480 shows signal waveforms indicative of a person speaking the numbers “1” through “6.”

FIG. 4J is an illustration 490 of signal waveforms indicative of various numbers and words detected by the communication device of FIG. 2. More specifically, the illustration 490 shows signal waveforms indicative of a person speaking the numbers “7” through “9” and the words “left” and “right.”

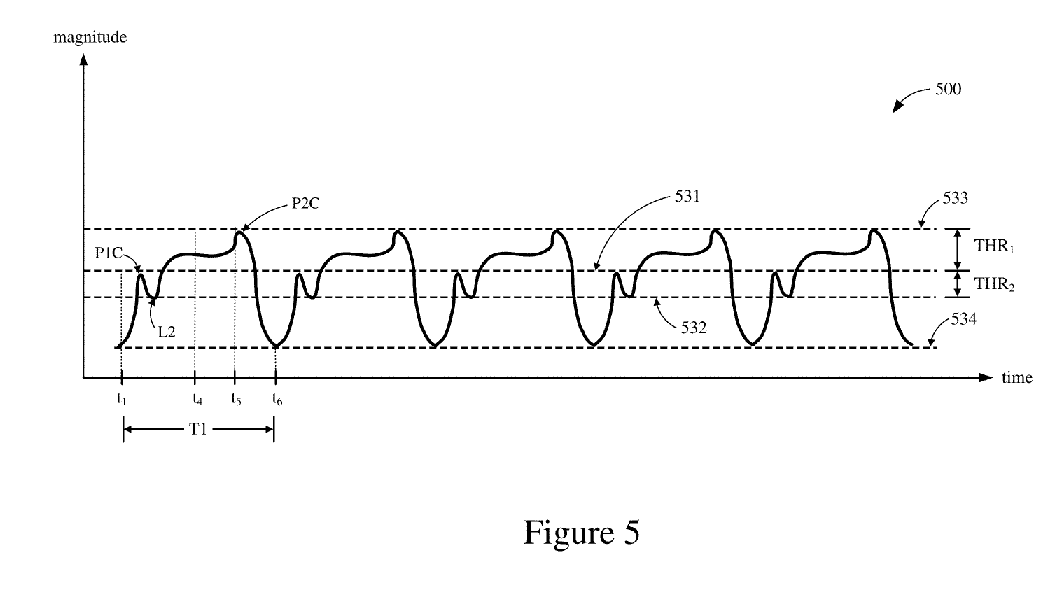

FIG. 5 shows an example composite signal 500. The signal 500 may be provided by contacts 210(1)-210(4) of the communication device 200, for example, in the manner described above with respect to FIGS. 2 and 3. The signal 500 of FIG. 5 exhibits a relatively constant periodicity. The signal 500 reaches a first peak P1C having a first magnitude 531 then drops off to a level L2 having a second magnitude 532, and then slowly increases to a second peak P2C corresponding to the maximum level 533. The first magnitude value 531 is less than the maximum level 533 by a first threshold amount (THR1), and the second magnitude value 532 is less than the first magnitude value 531 by a second threshold amount (THR2).

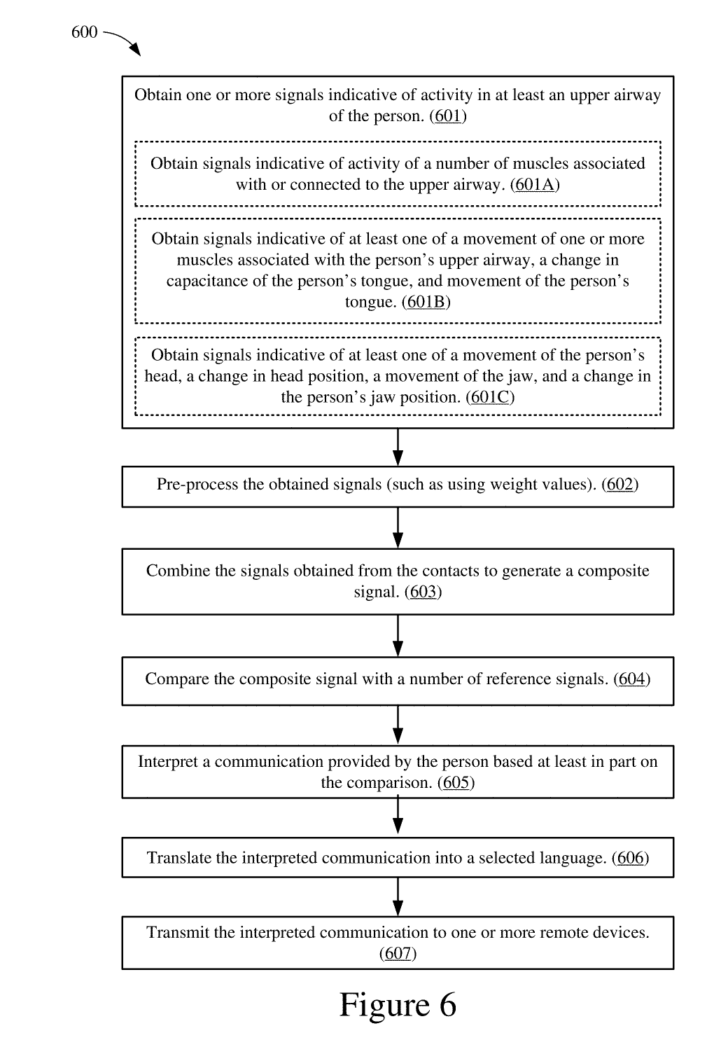

FIG. 6 is a flow chart depicting an example operation 600 for interpreting a person's speech in accordance with other aspects of the present disclosure. Although the example operation 600 is discussed below with respect to the communication device 200 of FIG. 2, the example operation 600 is equally applicable to other communication devices disclosed herein. Prior to operation, the communication device 200 is positioned within a suitable portion of the person's oral cavity, for example, so that the contacts 210 can detect activity of muscles, tissues, and other structures within or connected to the person's oral cavity. In some aspects, the communication device 200 may be positioned within a sublingual portion of the person's oral cavity. In other aspects, the communication device 200 may be modified to fit within an upper portion of the person's oral cavity.

Once properly fitted within the person's oral cavity, the communication device 200 may obtain one or more signals indicative of activity in at least an upper airway of the person (601). In some implementations, the one or more signals may be indicative of electrical activity of a number of muscles associated with or connected to the person's upper airway (601A). For example, the one or more signals may include EMG signals, EEG signals, EOG signals, or any combination thereof. In some aspects, the one or more signals may also include at least one of a heart rate signal, a Sp02 signal, a body temperature signal, an accelerometer signal, a heart rate variability signal, a heart rate turbulence signal, and a blood pressure signal.

In addition, or in the alternative, the one or more signals may be indicative of at least one of a movement of one or more muscles associated with the person's upper airway, a change in capacitance of the person's tongue, and a movement of the person's tongue (601B). In addition, or in the alternative, the one or more signals may be indicative of at least one of a movement of the person's head, a change in the person's head position, a movement of the jaw, and a change in the person's jaw position (601C).

In some implementations, the communication device 200 may pre-process the obtained signals such as, for example, using weight values to dynamically adjust the effects of each of the obtained signals has upon the composite signal (602). For example, if it is desirable to place more emphasis on first signals indicative of activity of one set of muscles than on second signals indicative of activity of another set of muscles, then the control circuit 820 may apply a greater weight value to the first signals than to the second signals, thereby ensuring that the first signals have more influence on the composite signals than do the second signals.

The communication device 200 may combine the signals obtained by the contacts 210, using any suitable techniques, to generate the composite signal (603). In some aspects, the composite signal may represent the activities of the muscles or tissues corresponding to all (or some specific set) of the contacts 210.

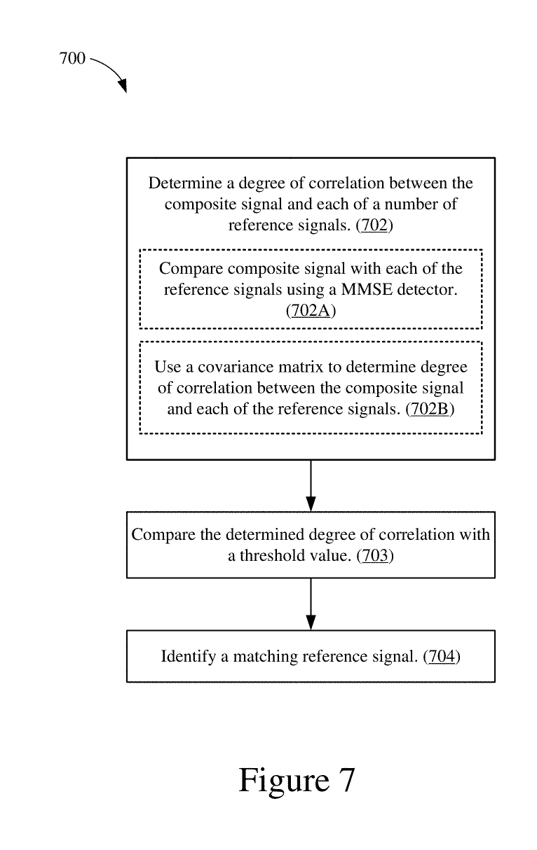

The communication device 200 may compare the composite signal with a number of reference signals (604). Each of the reference signals may be indicative of a corresponding letter, number, word, phrase, sentence, or command, and may be stored in the reference signal database 320A of the communication device 200. In some aspects, the communication device 200 may determine that the composite signal matches one of the reference signals (or a set of reference signals) if a variation between the composite signal and the matching reference signal is less than a threshold. The composite signal may be compared with the number of reference signals using suitable signal comparison or correlation technique, for example, as described below with respect to FIG. 7.

The communication device 200 may interpret a communication provided by the person based on the comparison (605). As described above, if the composite signal is determined to match one of the reference signals, then the communication device 200 may interpret the oral-based communication to be the letter, number, word, phrase, or sentence associated with the matching reference signals. In some aspects, the communication device 200 may use the matching reference signals as a look-up key or key to retrieve the corresponding letter, number, word, phrase, or sentence from the reference communication database 320B.

In some implementations, the communication device 200 may be configured to translate the interpreted communication into one or more selected languages (606). In some aspects, the communication device 200 may include a language translator (not shown for simplicity) that automatically translates words, phrases, and sentences associated with the interpreted communication into the one or more selected languages. In other aspects, the communication device 200 may use an off-device translator (not shown for simplicity) that automatically translates number, letter, word, sentence, or phrase associated with the interpreted communication into the one or more selected languages, and the an off-device translator may transmit the translated communication to the communication device 200, to a target device.

The communication device 200 may then transmit the interpreted communication to one or more remote devices (607). In some implementations, the interpreted communication may be used to communicate with one or more other persons having a suitable device to receive and decode the communications transmitted by the communication device 200. In addition, or in the alternative, the interpreted communication may be transmitted as commands that can control a number of operations of the one or more other devices, for example.

FIG. 7 is an illustrative flow chart depicting an example operation 700 for comparing a composite signal with each of a number of reference signals. Although the example operation 700 is discussed below with respect to the communication device 200 of FIG. 2, the example operation 700 is equally applicable to other communication devices disclosed herein.

First, the communication device 200 may determine a degree of correlation between the composite signal and each of a number of reference signals (702). In some implementations, the communication device 200 may compare the composite signal with each of the reference signals using a MMSE detector (702A). In other implementations, the communication device 200 may use a covariance matrix to determine degree of correlation between the composite signal and each of the reference signals (702B).

The communication device 200 may compare the determined degree of correlation with a threshold value (703). In some aspects for which the composite signal is compared with each of the number of reference signals using a MMSE detector, the difference values provided by the MMSE may be compared with a threshold value. In other aspects for which the composite signal is compared with the number of reference signals using a covariance matrix, the resulting covariance may be compared with a threshold value.

Then, the communication device 200 may identify a matching reference signal based on the comparison (704). In some aspects for which the MMSE detector is used to determine degrees of correlation between the composite signal and the reference signals, the communication device 200 may determine a match with a given reference signal if the difference value indicated by the MMSE detector for the given reference signal is less than (or equal to) the threshold value. In other aspects for which the covariance matrix is used to determine degrees of correlation between the composite signal and the reference signals, the communication device 200 may determine a match with a given reference signal if the resulting covariance value is less than (or equal to) the threshold value. Otherwise, the communication device 200 may indicate that the person's oral-based communications was not interpreted.

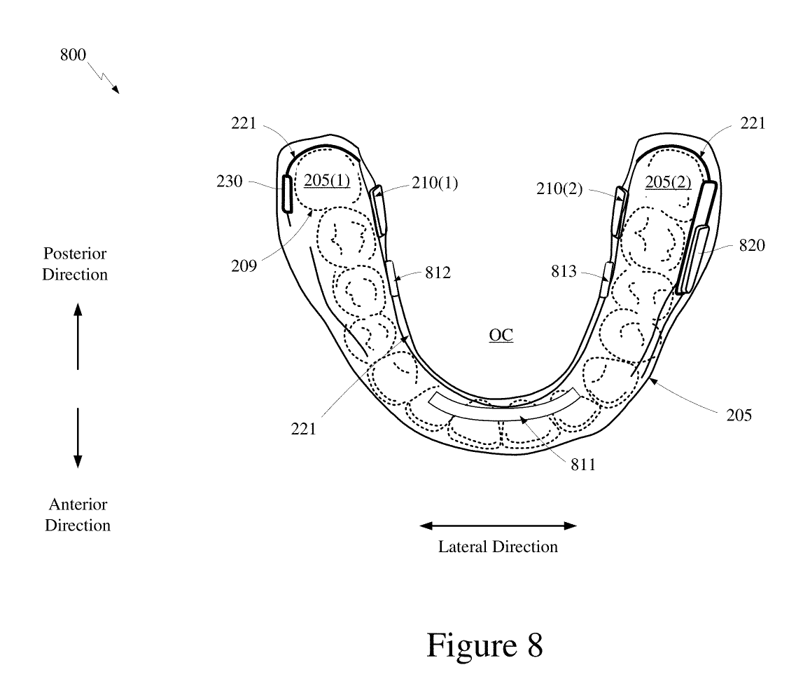

FIG. 8 shows a communication device 800 in accordance with other aspects of the present disclosure. For the example of FIG. 8, the communication device 800 is shown to include the appliance 205 upon which a number of the contacts 210(1)-210(2), the power source 230, a number of touch pads 811-813, and a control circuit 820 may be mounted (or otherwise attached to). Although not shown in FIG. 8 for simplicity, the communication device 800 may optionally include one or more sensors 212, for example, as discussed above with respect to FIG. 2. Further, although the example of FIG. 8 shows only two contacts 210(1)-210(2), in other implementations, the communication device 800 may include any suitable number of contacts 210. Similarly, although the example of FIG. 8 shows only three touch pads 811-813, in other implementations, the communication device 800 may include any suitable number of touchpads 811-813.

In some implementations, the communication device 800 may be a unitary and removable device adapted to fit entirely within a person's oral cavity OC (see also FIG. 1A), for example, such that there are no components external to the person's body. In some aspects, the appliance 205 may be adapted to fit over a person's lower teeth so as to be positioned within a sublingual portion of the person's oral cavity OC, for example, as depicted in FIG. 8. In other aspects, the appliance 205 may be adapted to fit over a person's upper teeth so as to be positioned within an upper portion of the person's oral cavity oral cavity (not shown for simplicity). In some other aspects, the communication device 800 may be of other suitable configurations or structures.

The appliance 205 may include one or more conductive wires or traces 221 that electrically couple the contacts 210(1)-210(2) and the touch pads 811-813 to the control circuit 220. The wires 221 also may couple the control circuit 220 to the power source 230. In some implementations, the wires 221 may be positioned either within or on an outside surface of the appliance 205, and therefore do not protrude into or otherwise contact the person's tongue or oral tissue. The power source 230 may be mounted in any of several locations on the appliance 205 and may be any suitable power supply (such as a battery) that provides power to the control circuit 220. In some aspects, active functions of the contacts 210(1)-210(2) may be controlled using bi-directional gating techniques that regulate the voltages and/or currents within the wires 221. For one example, in a sensing mode, the wires 221 may route signals detected or obtained by the contacts 210(1)-210(2) to the control circuit 220. For another example, in a therapeutic mode, the wires 221 may deliver stimulation waveforms to the contacts 210(1)-210(2), which in turn may provide electrical stimulation to one or more portions of the person's upper airway (such as to reduce apnea or snoring). The contacts 210(1)-210(2) may be arranged or positioned in any suitable manner, for example, as described above with respect to FIG. 2.

The touchpads 811-813 may be any suitable pad, contact, or other sensing device or component that can detect clicks, taps, gestures, and other movements of the person's tongue. For example, the touchpads 811-813 may be capacitive touchpads, force-sensitive touchpads, or the like. In some implementations, the touchpads 811-813 may use single or multimodal detection techniques to detect clicks, taps, gestures, and other movements of the person's tongue and to translate these detected tongue movements into a number of command signals. In some aspects, the touchpads 811-813 may detect a combination of tongue movements and generate command signals (such as multiple varying signals) that can be cross-correlated to determine one or more specific commands

In some implementations, the touchpad 811 may be designated as the primary touchpad, and the touchpads 812-813 may be designated as secondary touchpads. As depicted in FIG. 8, the primary touchpad 811 may be positioned on a portion of the appliance 205 proximate to a number of the person's front teeth in a manner that allows the primary touchpad 811 to detect clicking, tapping, and swiping gestures of the person's tongue. In some aspects, the primary touchpad 811 may be configured to detect a swiping gesture of the person's tongue in a left-to-right direction and in a right-to-left direction. The swiping gestures detected by the primary touchpad 811 may be translated into gesture-based commands that can control the movement of a remote device or the movement of an object associated with the remote device.

The secondary touchpads 812-813 may be positioned on opposing portions of the appliance 205 in a manner that allows the secondary touchpads 812-813 to detect clicking or tapping gestures of the tongue. The clicking or tapping gestures detected by the secondary touchpads 812-813 may be translated into tap-based commands that can control binary operations of the remote device or an object associated with the remote device. In some aspects, the secondary touchpads 812-813 may be configured to independently detect tap-based gestures, for example, to provide independent input mechanisms for the communication device 800. In other aspects, the secondary touchpads 812-813 may be configured to collectively detect tap-based gestures, for example, to provide sequence-based input mechanisms for the communication device 800.

The control circuit 820 may interpret one or more commands based on the signals provided by the touchpads 811-813, and provide the commands to a remote device. In some aspects, the control circuit 820 may perform one or more signal processing functions such as amplification, analog to digital conversion, rectification, filtering, mean calculations, integration, and Fast Fourier Transform (FFT) to interpret the signals associated with the detected tongue movements and gestures. The control circuit 820 may provide the commands to a transceiver (not shown in FIG. 8) for transmission to one or more remote devices. In this manner, the communication device 800 may allow the person to silently control or operate one or more remote devices based on the person's tongue movements and gestures.

For an example implementation disclosed herein, the primary touchpad 811 may be configured to detect swiping gestures made by the tongue. In some aspects, when a person slides the tongue on the touchpad 811 in a left-to-right direction, the touchpad 811 may provide signals to the control circuit 820 indicative of a left-to-right swiping gesture; when the person slides the tongue on the touchpad 811 in a right-to-left direction, the touchpad 811 may provide signals to the control circuit 820 indicative of a right-to-left swiping gesture. In some aspects, the touchpad 811 also may be force-sensitive, for example, to determine a multitude of touch inputs based on the amount of force applied by the tongue to the touchpad 811. The different levels of force detected by the touchpad 811 may be interpreted by the control circuit 820 as additional commands such as, for example, commands having an acceleration component.

Each of the secondary touchpads 812-813 may be configured to detect a clicking or tapping gesture made by the tongue. In some aspects, when a person makes a clicking gesture on the touchpad 812, the touchpad 812 may provide signals to the control circuit 820 indicative of a first selection command Similarly, when the person makes a clicking gesture on the touchpad 813, the touchpad 813 may provide signals to the control circuit 820 indicative of a second selection command In some aspects, the touchpads 812-813 also may be force-sensitive, for example, to determine a multitude of touch inputs based on the amount of force applied by the tongue to the touchpads 812-813. The different levels of force detected by the touchpads 812-813 may be interpreted as additional commands For example, that may include an acceleration component.

For one example in which the remote device is a wheelchair, a left-to-right swiping gesture detected by the touchpad 811 may cause the wheelchair to steer towards the right, a right-to-left swiping gesture detected by the touchpad 811 may cause the wheelchair to steer towards the left, an increasing amount of force detected by the touchpad 811 may cause the wheelchair to go faster, and a decreasing amount of force detected by the touchpad 811 may cause the wheelchair to go slower. In addition, clicking gestures detected by the touchpad 812 may cause the wheelchair to power on and off, and clicking gestures detected by the touchpad 813 may cause the wheelchair to initiate and terminate motion. In other aspects, the gestures detected by the touchpads 811-813 may be used to control other operations or functions of the wheelchair.

For another example in which the remote device is a computer or other device having a display, a left-to-right swiping gesture detected by the touchpad 811 may cause an object presented on the display to move in the left-to-right direction, a right-to-left swiping gesture detected by the touchpad 811 may cause the object presented on the display to move in the right-to-left direction, an increasing amount of force detected by the touchpad 811 may cause the presented object to more quickly move across the display, and a decreasing amount of force detected by the touchpad 811 may cause the presented object to more slowly move across the display. In addition, clicking gestures detected by the touchpad 812 may cause a selection of the presented object, and clicking gestures detected by the touchpad 813 may perform another function or operation of the presented object to. In other aspects, the gestures detected by the touchpads 811-813 may be used to control other operations or functions of the display.

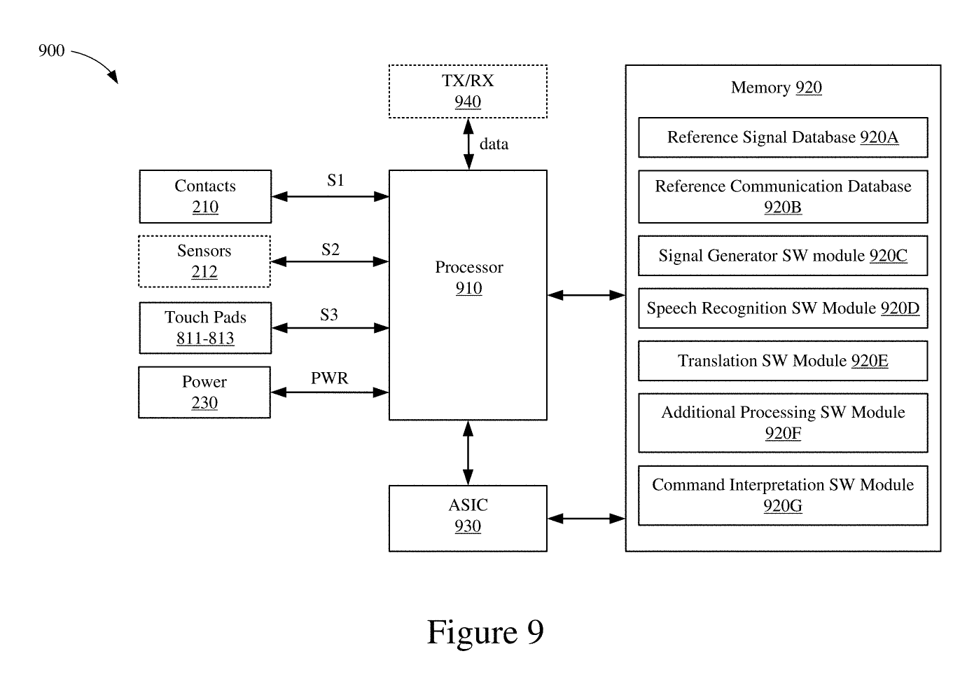

FIG. 9 shows a block diagram of a control circuit 900 that may be one implementation of the control circuit 820 of FIG. 8. The control circuit 900 is shown to include a processor 910, a memory 920, an ASIC 930, and an optional transceiver 940. The processor 910, which may be any one or more suitable processors capable of executing scripts or instructions (such as software programs stored in the memory 920), may be coupled to the memory 920, the ASIC 930, and the transceiver 940. The processor 910 is also depicted as being coupled to the contacts 210, to optional sensors 212, to the touch pads 811-813, and to the power supply 230 of the communication device 800 of FIG. 8. As depicted in the example of FIG. 9, the processor 910 may receive signals S1 obtained by the contacts 210, may receive signals S2 provided by the sensors 212, may receive signals S3 provided by the touchpads 811-813, and may provide power to the power supply 230.

In some implementations, the processor 910 may control the power supply 230 using a power control signal PWR. For one example, the processor 910 may instruct the power supply 230 to selectively provide power to the contacts 210 only for periods of time for which the contacts 210 are to be active (such as providing electrical stimulation to the person's upper airway). In this manner, power consumption of the control circuit 900 may be reduced, and the transmission of electrical signals on wires 221 (see also FIG. 2) may be reduced.

The memory 920, which may be any suitable type of memory or storage device, may store data to be transmitted from the communication device 300, may store data received from other devices, and may store other suitable information for facilitating the operation of the communication device 800. The memory 920 may include a reference signal database 920A that stores a number of reference signals associated with a number of letters, numbers, words, phrases, and/or sentences. In some aspects, the reference letters, numbers, words, phrases, and/or sentences may be stored in the reference signal database 920A. In other aspects, the reference letters, numbers, words, phrases, and/or sentences may be stored in a reference communications database 920B. A reference signal determined to match a composite signal based on one or more signals obtained from the contacts 210 may be used as a look-up key or value to retrieve the corresponding letter, number, word, phrase, or sentence from the reference communications database 920B.

The memory 920 may be or include a non-transitory computer readable medium that may store one or more of the following programs or software (SW) modules:
a signal generator SW module 920C to obtain, from the contacts 210, one or more signals indicative of activity in a person's upper airway while the person is engaging in oral-based communications;
a speech recognition SW module 920D to interpret the oral-based communications based on the signals obtained by one or more of the contacts 210 or based on a composite signal;
a translation SW module 920E to translate the interpreted communications into one or more selected languages;
an additional processing SW module 920F to selectively provide additional signal processing to the signals obtained by the contacts the contacts 210; and
a command interpretation SW module 920G to interpret user commands based on signals provided by the contacts 210, the touch pads 811-813, or any combination thereof.

The processor 910 may execute the signal generator SW module 920C to obtain, from the contacts 210, one or more signals indicative of activity in a person's upper airway when the person is engaging in oral-based communications. In some aspects, the processor 910 may execute the signal generator SW module 920C to generate a composite signal based on one or more of the signals obtained by the contacts 210, for example, as described above with respect to FIG. 3. The processor 910 also may execute the signal generator SW module 920C to receive signals from one or more of the touchpads 811-813. The signals provided by the touchpads 811-813 may be indicative of a number of various gestures such as, for example, swiping gestures, clicking gestures, and tapping gestures.

The processor 910 may execute the speech recognition SW module 920D to interpret the oral-based communications based on the obtained signals or the composite signal in a manner similar to that described above with respect to the speech recognition SW module 320C of FIG. 3. The communication device 800 may detect the words or phrases “spoken” by the person, translate the interpreted communication into the target language, and then transmit the translated communication to another device (such as using Bluetooth or Wi-Fi signals). In some aspects, the communication device 200 also may play the translated communication back to the person, for example, so that the person can use the communication device 200 as a translator.

The processor 910 may execute the translation SW module 920E to translate the interpreted communications into one or more selected languages in a manner similar to that described above with respect to the speech recognition SW module 320D of FIG. 3. In some implementations, the processor 910 may execute the translation SW module 920F to perform simultaneous translation, for example, so that a person may select a target language, and then “speak” silently while the communication device 200 is active. In response thereto, the communication device 200 may detect the words or phrases “spoken” by the person, translate the interpreted communication into the target language, and then transmit the translated communication to another device (such as using Bluetooth or Wi-Fi signals). In some aspects, the communication device 200 also may play the translated communication back to the person, for example, so that the person can use the communication device 200 as a translator.

The processor 910 may execute the additional processing SW module 920E to selectively provide additional signal processing to the signals obtained by the contacts 210(1)-210(n).

The processor 910 may execute the command interpretation SW module 920G to interpret one or more commands based on signals obtained by the contacts 210, based on signals provided by the touch pads 811-813, or both. As described above, in some aspects, the primary touchpad 811 may be configured to detect swiping gestures made by the tongue, and each of the secondary touchpads 812-813 may be configured to detect a clicking or tapping gesture made by the tongue. Execution of the command interpretation SW module 920G may be used to translate the gestures detected by the touchpads 811-813 into a number of commands, for example, that can be used to control operations or functions of a number of remote devices.

The ASIC 930 may include one or more ASICs or other suitable hardware components (such as FPGAs) that can be perform the functions of one or more of the SW modules stored in the memory 920. In some implementations, the ASIC 930 may include or perform the functions of a MMSE detector, for example, to determine a degree of correlation between the composite signal and each of the reference signals. In addition, or in the alternative, the ASIC 930 may include or perform the functions of a covariance matrix, for example, to determine a degree of correlation between the composite signal and each of the reference signals.

As described above with respect to FIG. 3, the control circuit 900 may provide the interpreted communications to the transceiver 940, which in turn may transmit the interpreted communications to a remote device (or multiple remote devices). In this manner, a user of the communication device 800 may transmit oral-based communications to one or more other devices using audible speech, inaudible speech, or silent speech. In some aspects, the remote device may be another communication device that provides the interpreted communication to user of the remote device. In other aspects, the remote device may be configured to receive the interpreted communication as a command to perform some action.

In addition, or as an alternative, the control circuit 900 may provide the interpreted commands to the transceiver 940, which in turn may transmit the interpreted commands to one or more remote devices. More specifically, as described above with respect to FIG. 8, the touchpads 811-813 may be configured to detect a variety of gestures and movements of the person's tongue, and may provide signals indicative of the tongue gestures and movements to the control circuit 900. In response thereto, the control circuit 900 may determine one or more commands based on the signals provided by the touchpads 811-813, and the transceiver 940 may transmit the commands to one or more remote devices.

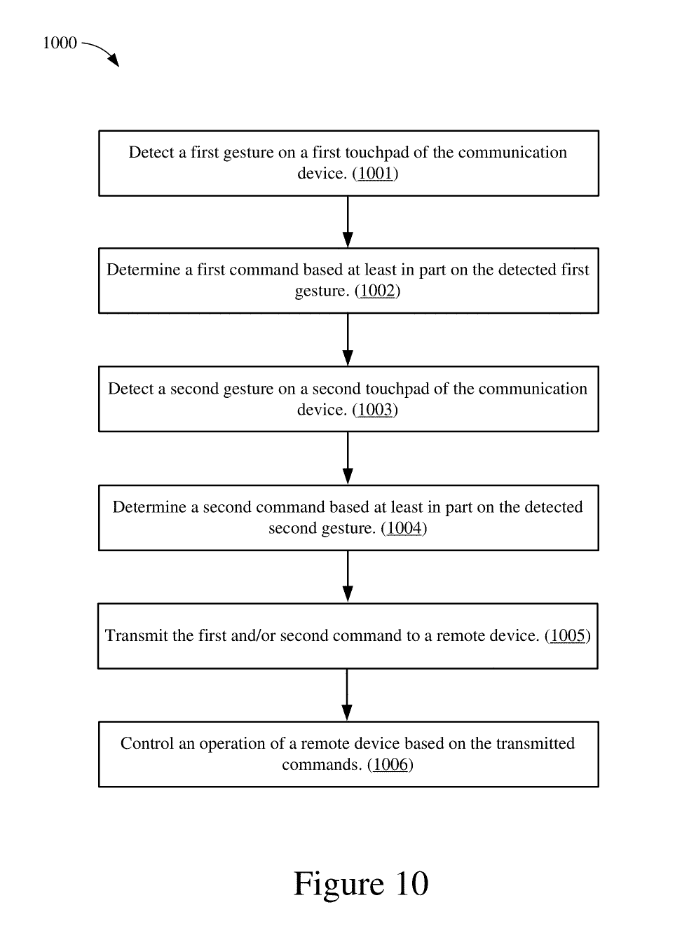

FIG. 10 is an illustrative flow chart of an example operation 1000 for interpreting tongue-based commands Although the example operation 1000 is discussed below with respect to the communication device 800 of FIG. 8, the example operation 1000 is equally applicable to other communication devices disclosed herein. Prior to operation, the communication device 800 is positioned within a suitable portion of the person's oral cavity, for example, so that the contacts 210 can detect activity of muscles, tissues, and other structures within or connected to the person's oral cavity and so that the touchpads 811-813 can detect various tongue gestures and movements. In some aspects, the communication device 800 may be positioned within a sublingual portion of the person's oral cavity. In other aspects, the communication device 800 may be modified to fit within an upper portion of the person's oral cavity.

Once properly fitted within the person's oral cavity, the communication device 800 may detect a first gesture on a first touchpad 811 of the communication device 800 (1001). In some implementations, the first touchpad 811 may be a touch sensitive contact integrated within the appliance, and positioned over a portion of the person's front teeth. In some aspects, the first gesture may be one of a swipe gesture, a click gesture, and a hold gesture. In addition, or in the alternative, the first touchpad 811 also may be a force-sensitive contact configured to detect an amount of force applied by the tongue to the first touchpad 811.

The communication device 800 determines a first command based at least in part on the detected first gesture (1002). In some aspects, the first command may be a directional command based on a direction of the swiping gesture made by the tongue on the first touchpad 811. In other aspects, the first command may be a selection command based on a tapping gesture made by the tongue on the first touchpad 811. In some other aspects, the first command may be another command based on the amount of force applied to the first touchpad 811 by the tongue.

The communication device 800 may detect a second gesture on a second touchpad 812 of the communication device 800 (1003). In some implementations, the second touchpad 812 may be a touch sensitive contact integrated within the appliance, and positioned over a portion of the person's anterior molar locations. In some aspects, the second gesture may be one of a clicking gesture, a tapping gesture, and a hold gesture. In addition, or in the alternative, the second touchpad 812 also may be a force-sensitive contact configured to detect an amount of force applied by the tongue to the second touchpad 812.

The communication device 800 determines a second command based at least in part on the detected second gesture (1004). In some aspects, the second command may be a selection command based on a clicking gesture made by the tongue on the second touchpad 812. In other aspects, the second command may be a selection command based on a hold and release gesture made by the tongue on the second touchpad 812. In some other aspects, the second command may be another command based on the amount of force applied to the second touchpad 812 by the tongue.

The communication device 800 may transmit the first and/or second command to a remote device (1005), and may control an operation of a remote device based on the transmitted commands (1006). For example, the remote device may be a wheelchair, and a left-to-right swiping gesture detected by the touchpad 811 may cause the wheelchair to steer towards the right, a right-to-left swiping gesture detected by the touchpad 811 may cause the wheelchair to steer towards the left, an increasing amount of force detected by the touchpad 811 may cause the wheelchair to go faster, and a decreasing amount of force detected by the touchpad 811 may cause the wheelchair to go slower.

As mentioned above, the remote device may be any suitable device that is configured to perform some function or take some action in response to receiving the commands provided by the communication device 800. In one aspect, the remote device may be a vehicle, and the interpreted communication may be one or more instructions to control a number of operations of the vehicle (such as a movement of the vehicle, a speed of the vehicle, a return-to-home function of the vehicle, a locking of the vehicle, an unlocking of the vehicle, and an enabling of one or more user features of the vehicle). For example, the vehicle may be a wheelchair, and the communication device 800 may allow a person to control the wheelchair using swiping gestures provided on the primary touchpad 811 and/or clicking gestures provided on the secondary touchpads 812-813, for example, as described above.

In another aspect, the remote device may be a display device, and the interpreted command may be one or more instructions to control a number of operations of the display device (such as a movement of a cursor or other object presented on the display device, a selection of an object presented on the display device, a dismissal of an object presented on the display device, and a gesture on the display device) using one or more gestures provided on the touchpads 811-813.

In another aspect, the remote device may be a computer, and the interpreted command may be one or more instructions to control a number of operations of the computer (such as turning on the computer, turning off the computer, opening an executable application on the computer, performing one or more functions within an executed application on the computer, providing one or more voice commands to the computer) using one or more gestures provided on the touchpads 811-813.

In another aspect, the remote device may be a home appliance, and the interpreted command may be one or more instructions to control a number of operations of the home appliance (such as turning on the home appliance, turning off the home appliance, and adjusting one or more settings of the home appliance) using one or more gestures provided on the touchpads 811-813.

In another aspect, the remote device may be a TV, and the interpreted command may be one or more instructions to control a number of operations of the TV (such as turning the TV on and off, changing channels, adjusting the volume level, and so on) using one or more gestures provided on the touchpads 811-813.

In another aspect, the remote device may be a piece of military equipment, and the interpreted command may be one or more instructions to control a number of operations of the military equipment (such as turning the TV on and off, changing channels, adjusting the volume level, and so on) using one or more gestures provided on the touchpads 811-813. For one example, the communication device 800 may allow a soldier to simultaneously control a variety of weapons, vehicles, and other devices based on tongue gestures provided on the touchpads 811-813—all without making noise normally associated with speaking. For another example, the communication device 800 may allow the soldier to call in airstrikes using either silent speech or the touchpads 811-813 in without making any noise.

Moreover, the communication device 800 may serve as an Augmentative and Alternative Communication (AAC) that may aid persons with cerebral palsy, intellectual impairment, autism, developmental verbal dyspraxia, traumatic brain injury, aphasia, locked-in syndrome, amyotrophic lateral sclerosis (ALS), Parkinson's disease, multiple sclerosis (MS), and dementia to communicate with other people and to control the operation of a wide variety of remote devices.

An example operation for setting up the communication device 800 is described below. First, the person inserts the communication device 800 into his mouth, and ensures that the appliance 805 is properly fitted therein. In some implementations, the communication device 800 may be configured to automatically power-on when the appliance 805 is properly fitted within the person's oral cavity. In some aspects, the communication device 800 may selectively power-on based on detection of one or more signals by the contacts 210. For example, if the contacts 210 detect signals indicating activity in the person's oral cavity or upper airway (such as EMG signals indicating electrical activity in the person's upper airway), then the communication device 800 may automatically power-on; conversely, if the contacts 210 do not detect signals indicating activity in the person's oral cavity or upper airway (which may indicate that the appliance 805 is not positioned within the person's oral cavity), then the communication device 800 may not power-on. In other aspects, the communication device 800 may selectively power-on based on electrical contact between a number of the contacts 210 and corresponding portions of the person's oral cavity. For example, the communication device 800 may be configured to detect a closed circuit between a selected set of the contacts 210 when the selected set of the contacts 210 are in electrical contact with muscles or tissue of the person's oral cavity.

In other implementations, the communication device 800 may be powered-on based on the person activating a power button or switch, based on the person sending a power-on signal to the communication device 800 (such as from the person's smartphone), or based on any other suitable manual power-on mechanism.

In instances where the device has insufficient battery, is inactive, broken, or needs repair, the device APP which is operated via the personal devices paired with the communication device 800 will run a systems check to verify the status of the communication device 800. If the APP detects a problem of any kind, the phone or computer paired with the communication device 800 will send an alert to the user. The communication device 800 will stay connected via Bluetooth with one or many of the specified users electronic devices. The setting and preferences of the communication device 800 settings can be accessed and changed on any of the specified users personal electronic devices to which the device is paired under the APP. The communication device 800 can learn and adapt to your device preferences depending on location, time of day, and with whom you are interacting.

Security: The communication device 800 may be configured to will learn and adapt to the unique differences in the users muscle movements during speech compared to waveforms stored in the device's database to improve accuracy and eliminate discrepancies as quickly and efficiently as possible. This concept reduces the chance of the device getting lost or stolen. The communication device 800 can only be used by the specified user and no one else. This creates a new level of personalized security among wireless electronics.

The user can select and change which devices the IM connects to at any given time by saying, “connect to USER's phone” or “connect to USER's laptop” or “connect to USER's phone and laptop.” The user can select and change which devices the communication device 800 connects to outside of its internal network as well by saying, “connect to [CONTACT NAME] phone” or “connect to [CONTACT NAME] laptop” or “connect to [CONTACT NAME] phone or laptop.” The user has the option to connect to multiple external devices as long as permission has been granted by other users to access their devices. The user can check which external devices the communication device 800 is connected to at any time via the APP on the users personal electronic devices.

What is claimed is:

1. A communication device configured to fit within an oral cavity of a person, the communication device comprising:
a number of contacts adapted to be positioned within the oral cavity and configured to obtain one or more signals indicative of activity in at least an upper airway of the person; and
a control circuit configured to interpret a communication provided by the person based at least in part on the one or more obtained signals.

2. The communication device of claim 1, further comprising:
an appliance, coupled to the number of contacts and the control circuit, and configured to relay signals between the contacts and the control circuit.

3. The communication device of claim 2, wherein the appliance comprises a dental retainer configured to fit over a number of teeth of the person.

4. The communication device of claim 2, wherein the number of contacts are integrated within the appliance.

5. The communication device of claim 2, wherein the communication device is one member of the group consisting of a floating device, a tethered device, a device configured to be clipped to one or more teeth of the person, and a device configured be adhesively attached to one or more teeth of the person.

6. The communication device of claim 1, wherein at least one of the contacts is one member of the group consisting of an electrode, an implant, a filling, and a piercing.

7. The communication device of claim 1, wherein the one or more obtained signals are indicative of electrical activity of a number of muscles associated with or connected to the person's upper airway.

8. The communication device of claim 7, wherein the one or more obtained signals comprise at least one of an EMG signal, an EEG signal, and an EOG signal.

9. The communication device of claim 7, wherein the one or more obtained signals further comprise at least one of a heart rate signal, a Sp02 signal, a body temperature signal, an accelerometer signal, a heart rate variability signal, a heart rate turbulence signal, and a blood pressure signal.

10. The communication device of claim 1, wherein the one or more obtained signals are indicative of at least one of a movement of one or more muscles associated with the person's upper airway, a change in capacitance of the person's tongue, and movement of the person's tongue.

11. The communication device of claim 1, wherein the one or more obtained signals are indicative of at least one of a movement of the person's head, a change in the person's head position, a movement of the jaw, and a change in the person's jaw position.

12. The communication device of claim 1, further comprising:
a number of sensors including at least of a Sp02 sensor, a temperature sensor, an accelerometer, a heart rate signal sensor, and a blood pressure sensor.

13. The communication device of claim 1, wherein the control circuit comprises a comparator configured to interpret the communication by comparing the one or more obtained signals with a reference signal.

14. The communication device of claim 13, wherein reference signal comprises a composite signal based on a plurality of sets of previously obtained signals.

15. The communication device of claim 14, wherein the control circuit further comprises a memory configured to store the composite signal.

16. The communication device of claim 1, wherein the one or more obtained signals are obtained while a jaw of the person is mobile.

17. The communication device of claim 1, wherein the one or more obtained signals are obtained while a jaw of the person is immobile.

18. The communication device of claim 1, wherein the communication is one member of the group consisting of audible speech, whispering, and inaudible speech.

19. The communication device of claim 18, wherein the inaudible speech comprises at least one of speech with no jaw movement and speech with no external muscle movements.

20. The communication device of claim 19, wherein the interpreted communication comprises at least one of a letter, a number, a word, a phrase, a sentence, and a paragraph.

21. The communication device of claim 1, further comprising:
a transceiver coupled to the control circuit and configured to transmit the interpreted communication to a remote device.

22. The communication device of claim 21, wherein the remote device comprises a vehicle, and the interpreted communication comprises one or more instructions to control a number of operations of the vehicle.

23. The communication device of claim 22, wherein the vehicle is at least one of a wheelchair, a car, a truck, an airplane, a drone, and a boat, and the number of operations include at least one of a movement of the vehicle, a speed of the vehicle, a return-to-home function of the vehicle, a locking of the vehicle, an unlocking of the vehicle, and an enabling of one or more user features of the vehicle.

24. The communication device of claim 21, wherein the remote device comprises a display device, and the communication comprises one or more instructions to control a number of operations of the display device.

25. The communication device of claim 24, wherein the number of operations include at least one of a movement of a cursor presented on the display device, a selection of an object presented on the display device, a dismissal of an object presented on the display device, and a gesture on the display device.

26. The communication device of claim 21, wherein the remote device comprises a computer, and the communication comprises one or more instructions to control a number of operations of the computer.

27. The communication device of claim 26, wherein the number of operations includes at least one of turning on the computer, turning off the computer, opening an executable application on the computer, performing one or more functions within an executed application on the computer, providing one or more voice commands to the computer.

28. The communication device of claim 21, wherein the remote device comprises a home communication device, and the communication comprises one or more instructions to control a number of operations of the home communication device.

29. The communication device of claim 28, wherein the number of operations includes at least one of turning on the home communication device, turning off the home communication device, and adjusting one or more settings of the home communication device.

30. The communication device of claim 21, further comprising:
a transceiver coupled to the control circuit and configured to transmit the interpreted communication to one or more selected people.

31. The communication device of claim 30, wherein the transceiver is further configured to receive communications from one or more external sources.

32. The communication device of claim 1, further comprising:
a translation circuit coupled to the control circuit and configured to translate the interpreted communication from a first language to a second language.

33. The communication device of claim 32, wherein the control circuit is further configured to select the second language, from a plurality of languages, based at least in part on the one or more obtained signals.

34. A communication device, comprising:
an appliance configured to fit within an oral cavity of a person;
a first touchpad coupled to the appliance and configured to detect a first gesture performed by the person's tongue; and
a control circuit configured to determine a first command based at least in part on the detected first gesture.

35. The communication device of claim 34, wherein the appliance comprises a dental retainer configured to fit over a number of teeth of the person.

36. The communication device of claim 34, wherein the first touchpad comprises a touch sensitive contact integrated within the appliance, and the first gesture is at least one of a swipe gesture, a click gesture, and a hold gesture.

37. The communication device of claim 34, wherein the first touchpad comprises a force-sensitive contact configured to detect an amount of force applied by the tongue.

38. The communication device of claim 37, wherein the control circuit is further configured to determine a second command based on the amount of force applied by the tongue.

39. The communication device of claim 38, further comprising:
a transceiver coupled to the control circuit and configured to transmit the first and second commands to a remote device.

40. The communication device of claim 39, wherein the remote device comprises a vehicle, the first operation comprises controlling a direction of the vehicle based on a direction of a swipe gesture detected by the first touchpad, and the second operation comprises controlling a speed of the vehicle based on the amount of force applied by the tongue.

41. The communication device of claim 39, wherein the remote device comprises a display, the first operation comprises controlling a direction of an object presented on the display based on a direction of a swipe gesture detected by the first touchpad, and the second operation comprises controlling a speed of the object presented on the display based on the amount of force applied by the tongue.

42. The communication device of claim 34, further comprising:
a second touchpad coupled to the appliance and configured to detect a second gesture performed by the person's tongue, wherein the control circuit is configured to determine a second command based at least in part on the detected second gesture.

43. The communication device of claim 42, wherein the second touchpad comprises a force-sensitive contact configured to detect an amount of force applied by the tongue.

44. The communication device of claim 43, wherein the control circuit is further configured to determine an additional command based on the amount of force applied by the tongue.

45. The communication device of claim 42, further comprising:
a transceiver coupled to the control circuit and configured to transmit the first and second commands to a remote device.

46. The communication device of claim 45, wherein the remote device comprises a vehicle, the first operation comprises controlling a direction of the vehicle based on a direction of a swipe gesture detected by the first touchpad, and the second operation comprises powering the vehicle on and off based on a tapping gesture detected by the second touchpad.

47. The communication device of claim 45, wherein the remote device comprises a display, the first operation comprises controlling a direction of an object presented on the display based on a direction of a swipe gesture detected by the first touchpad, and the second operation comprises controlling a selection of the object presented on the display based on a tapping gesture detected by the second touchpad.

48. The communication device of claim 47, wherein the control circuit is configured to cause a dismissal of the object based on a second direction of the swipe gesture detected by the first touchpad.
